(19) United States
(12) Patent Application Publication
(10) Pub. No.: US 2026/0253106 A1
(43) Pub. Date: Aug. 27, 2026

(54) SYSTEM

(71) Applicant: SoftBank Group Corp., Tokyo (JP)

(72) Inventor: Tomoko NAKAMOTO, Tokyo (JP)

(73) Assignee: SoftBank Group Corp., Tokyo (JP)

(21) Appl. No.: 19/533,497

(22) Filed: Feb. 9, 2026

(30) Foreign Application Priority Data
Feb. 21, 2025 (JP) 2025-026988

(51) Int. Cl. G06Q 30/0251; G06F 40/30; H04L 51/04

(52) U.S. Cl. CPC G06Q 30/0269; G06F 40/30; G06Q 30/0255; G06Q 30/0261; H04L 51/04

(57) ABSTRACT

The system according to the embodiment comprises an analysis unit, a selection unit, and a display unit. The analysis unit analyzes chat content. The selection unit selects an advertisement based on the content analyzed by the analysis unit. The display unit displays the advertisement selected by the selection unit.

### CROSS-REFERENCE TO RELATED APPLICATION

The present application claims priority to and incorporates by reference the entire contents of Japanese Patent Application No. 2025-026988 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it cannot be said that appropriate advertisements are sufficiently displayed based on chat content, and there is room for improvement.

### SUMMARY OF THE INVENTION

The system according to the embodiment comprises an analysis unit, a selection unit, and a display unit. The analysis unit analyzes chat content. The selection unit selects an advertisement based on the content analyzed by the analysis unit. The display unit displays the advertisement selected by the selection unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

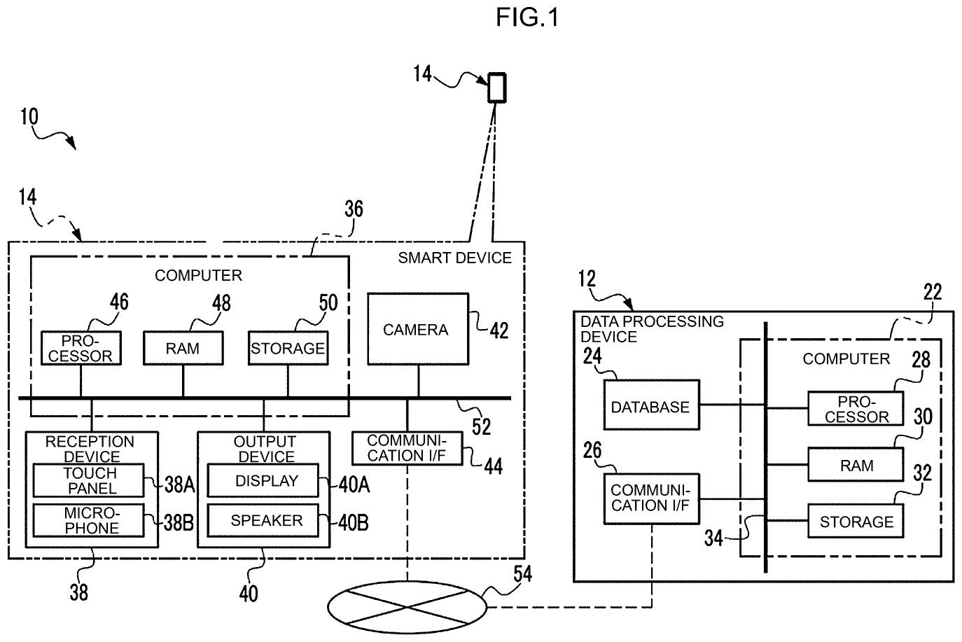

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

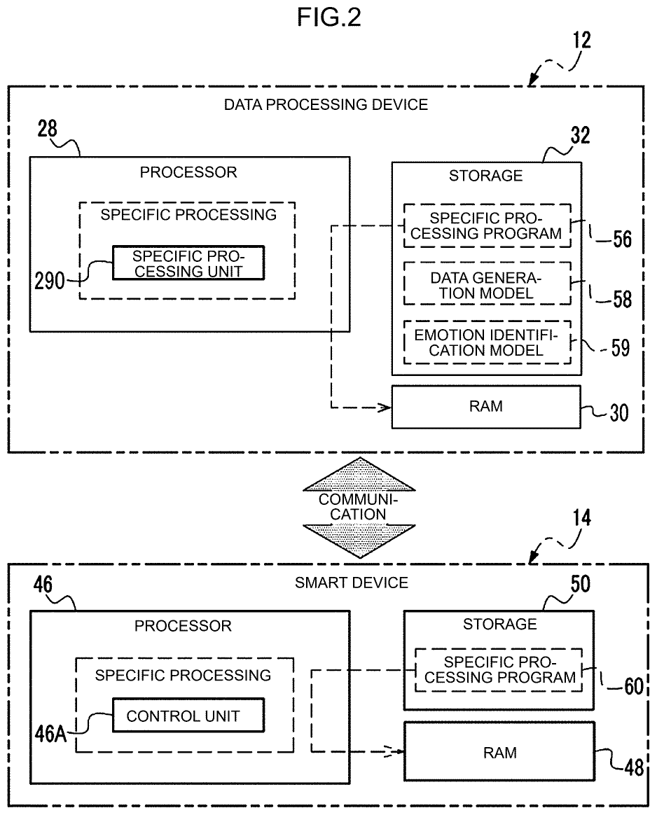

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The advertisement display system according to the embodiment of the present invention is a system that displays appropriate advertisements based on the chat content of a messenger application. This advertisement display system analyzes the chat content of the messenger application and understands the content of the conversation. Next, it selects appropriate advertisements based on the conversation content and displays them in advertisement slots within the messenger application. For example, if the user is having a conversation about searching for a place to go out, information about leisure spots is displayed in the advertisement slot. Through this mechanism, useful information can be provided to the user. First, AI is used to analyze the chat content of the messenger application. The AI analyzes the chat content using natural language processing technology and extracts topics and keywords from the conversation. For example, if there is a conversation such as “I want to go out somewhere on the weekend,” the AI extracts keywords such as “weekend” and “go out.” Next, based on the extracted keywords, appropriate advertisements are selected. For advertisement selection, the AI considers the user's past behavioral history and interests. For example, for users who have previously searched for information about leisure spots, advertisements for leisure spots are preferentially displayed. Finally, the selected advertisements are displayed in the advertisement slot within the messenger application. The advertisements are displayed in a part of the chat screen so that the user can naturally notice them. As a result, the user can obtain useful information related to the conversation content. This mechanism not only provides useful information to the user but also enables effective advertisement delivery for advertisers. For example, a travel agency can advertise its travel plans to users who are having conversations about travel. Similarly, a restaurant can advertise its menu to users who are having conversations about meals. Thus, the advertisement display system can provide useful information to users. Specifically, this advertisement display system receives chat content as input data, which may include various data types such as text messages (UTF-8 encoded string arrays, e.g., “I want to go out somewhere on the weekend,” “I'm looking for a new restaurant”), voice messages (WAV format sampled at 16 kHz, e.g., 5 seconds of audio data), and images (JPEG or PNG format, e.g., photos of tourist spots). The system first performs preprocessing on these input data, including noise removal, tokenization, conversion of speech to text (speech recognition), and feature extraction from images (CNN-based image encoder). Next, the natural language processing unit utilizes a large-scale language model based on the Transformer architecture to perform morphological analysis (e.g., MeCab algorithm), grammatical analysis (dependency parsing), and semantic analysis (contextual embedding using BERT or RoBERTa). Examples of input to the AI model include text such as “I want to go out somewhere on the weekend,” or multimodal data such as “photo of a restaurant” plus “voice conversation with a friend.” The AI model outputs keywords such as “weekend,” “go out,” “restaurant,” and topic labels such as “travel,” “meal” in the form of probability distributions (e.g., travel 0.85, meal 0.10, shopping 0.05). Furthermore, by inputting the user's behavioral history (e.g., search query vectors for the past 30 days, time-series arrays of click history, interest cluster IDs), the advertisement selection AI model (multi-layer perceptron or gradient boosting decision tree) calculates relevance scores for each advertisement candidate (e.g., leisure spot advertisement 0.92, restaurant advertisement 0.75, shopping advertisement 0.30). After advertisement selection, the display unit receives the selected advertisement data (structured data such as banner image URL, text, video ID, etc.) and dynamically renders it in the advertisement slot of the messenger application (HTML/CSS layout information, display position parameters). Examples of AI output include “Ad ID:12345, display position: top, relevance: 0.92,” “Ad ID:67890, display position: bottom, relevance: 0.75,” etc. As a subsequent process, click events and display counts of advertisements are collected in real time and sent to the advertisement effectiveness measurement unit, which can be used for online learning of the advertisement selection algorithm and A/B testing. Unlike conventional simple keyword matching or manual advertisement selection, the present invention achieves technical effects such as significantly improved relevance, display accuracy, and user experience by realizing AI processing that integrates semantic similarity calculation in high-dimensional vector space, user behavioral history, emotional state, and contextual information. The applicable fields are not limited to messenger applications but can be expanded to any user-interactive information service, such as SNS, email clients, voice assistants, and IoT device interfaces.

The advertisement display system according to the embodiment comprises an analysis unit, a selection unit, and a display unit. The analysis unit analyzes the chat content of the messenger application. The chat content may include, for example, text messages, voice messages, images, and the like, but is not limited thereto. The analysis unit analyzes the chat content using, for example, natural language processing technology. Natural language processing technology includes morphological analysis, grammatical analysis, semantic analysis, and the like. For example, the analysis unit divides words in the chat content using morphological analysis, analyzes sentence structure using grammatical analysis, and understands sentence meaning using semantic analysis. The selection unit selects advertisements based on the content analyzed by the analysis unit. The selection unit selects advertisements based on extracted keywords, for example. The selection unit may also select advertisements by considering the user's past behavioral history and interests. For example, the selection unit preferentially displays advertisements for leisure spots to users who have previously searched for information about leisure spots. The display unit displays the advertisements selected by the selection unit. The display unit displays advertisements in advertisement slots within the messenger application, for example. Advertisement slots may include banner advertisements, text advertisements, video advertisements, and the like, but are not limited thereto. For example, the display unit may display banner advertisements at the top of the chat screen. The display unit may also display text advertisements at the bottom of the chat screen. Furthermore, the display unit may display video advertisements at the center of the chat screen. Thus, the advertisement display system according to the embodiment can display appropriate advertisements based on the chat content of the messenger application. Some or all of the above-described processing in the display unit may be performed using AI or without using AI. For example, the display unit may use an AI model for displaying advertisements, using the advertisements selected by the selection unit as input, to display the advertisements. Specifically, as the analysis unit, this advertisement display system receives chat content as input data, which may include various data types such as UTF-8 encoded string arrays (e.g., “I want to go out somewhere on the weekend,” “I'm looking for a new restaurant”), WAV format audio data sampled at 16 kHz (e.g., 5 seconds of audio), and JPEG or PNG format images (e.g., photos of tourist spots). The analysis unit performs preprocessing on these input data, including noise removal, tokenization, conversion of speech to text (speech recognition), and feature extraction from images (CNN-based image encoder). Next, the natural language processing unit utilizes a large-scale language model based on the Transformer architecture to perform morphological analysis (e.g., MeCab algorithm), grammatical analysis (dependency parsing), and semantic analysis (contextual embedding using BERT or RoBERTa). Examples of input to the AI model include text such as “I want to go out somewhere on the weekend,” or multimodal data such as “photo of a restaurant” plus “voice conversation with a friend.” The analysis unit outputs keywords such as “weekend,” “go out,” “restaurant,” and topic labels such as “travel,” “meal” in the form of probability distributions (e.g., travel 0.85, meal 0.10, shopping 0.05). The selection unit receives the user's behavioral history (e.g., search query vectors for the past 30 days, time-series arrays of click history, interest cluster IDs) as input and, using an advertisement selection AI model (multi-layer perceptron or gradient boosting decision tree), calculates relevance scores for each advertisement candidate (e.g., leisure spot advertisement 0.92, restaurant advertisement 0.75, shopping advertisement 0.30). The selection unit selects the most relevant advertisement based on these scores. The display unit receives the selected advertisement data (structured data such as banner image URL, text, video ID, etc.) and dynamically renders it in the advertisement slot of the messenger application (HTML/CSS layout information, display position parameters). Examples of AI output include “Ad ID:12345, display position: top, relevance: 0.92,” “Ad ID:67890, display position: bottom, relevance: 0.75,” etc. As a subsequent process, click events and display counts of advertisements are collected in real time and sent to the advertisement effectiveness measurement unit, which can be used for online learning of the advertisement selection algorithm and A/B testing. Unlike conventional simple keyword matching or manual advertisement selection, the present invention achieves technical effects such as significantly improved relevance, display accuracy, and user experience by realizing AI processing that integrates semantic similarity calculation in high-dimensional vector space, user behavioral history, emotional state, and contextual information. The applicable fields are not limited to messenger applications but can be expanded to any user-interactive information service, such as SNS, email clients, voice assistants, and IoT device interfaces.

The advertisement display system comprises a collection unit configured to collect a user's behavioral history. The collection unit collects the user's behavioral history. The behavioral history may include, for example, website browsing history, purchase history, click history, and the like, but is not limited thereto. The collection unit collects website browsing history, for example. The collection unit can record the URLs of websites visited by the user and the content of pages viewed. The collection unit can also collect purchase history. The collection unit can record information about products purchased by the user through online shopping. Furthermore, the collection unit can collect click history. The collection unit can record information about advertisements or links clicked by the user. By collecting the user's behavioral history, the collection unit can improve the accuracy of advertisement selection. Some or all of the above-described processing in the collection unit may be performed using AI or without using AI. For example, the collection unit may use an AI model for collecting behavioral history, using the user's behavioral history as input, to collect behavioral history. Specifically, the collection unit collects structured data as the user's behavioral history data, such as website browsing history (string arrays of URLs, access timestamps, page titles and metadata), purchase history (product ID, category, purchase date, price, quantity), and click history (ad ID, click timestamp, display position, device information). The collection unit acquires these data in real time or by batch processing and stores them in a database. When using an AI model, the collection unit inputs the user's behavioral patterns as time-series vectors (e.g., time-series arrays of click events over the past 30 days, feature vectors for each event) and performs anomaly detection and behavioral clustering (e.g., K-means clustering, feature extraction using autoencoders) to remove noise data and automatically classify user segments. Examples of AI model output include “Cluster ID: 12, purchase tendency: high, click frequency: 0.85,” “anomaly behavior flag: False,” etc. Based on these outputs, the collection unit optimizes input data for the advertisement selection unit, automates filtering of unnecessary data, and feature extraction for each user. As a subsequent process, the collected behavioral history is transferred to the advertisement selection AI model and effectiveness measurement unit, and used for advertisement personalization and effectiveness analysis. Unlike conventional simple log collection, the collection unit of the present invention combines AI-based high-dimensional feature extraction, anomaly detection, and automatic clustering of user behavior to achieve technical effects such as improved data quality, collection efficiency, and real-time performance. The applicable fields include EC sites, SNS, video streaming services, IoT device usage history collection, and can be deployed as a platform for collecting and analyzing diverse user behavioral data.

The advertisement display system comprises a measurement unit configured to measure the effectiveness of the advertisement. The measurement unit measures the effectiveness of the advertisement. The effectiveness of the advertisement may include, for example, click-through rate, conversion rate, engagement rate, and the like, but is not limited thereto. The measurement unit measures the click-through rate, for example. The measurement unit can record the number of times an advertisement is displayed and the number of times it is clicked, and calculate the click-through rate. The measurement unit can also measure the conversion rate. The measurement unit can track the user's behavior after clicking the advertisement and calculate the conversion rate. Furthermore, the measurement unit can measure the engagement rate. The measurement unit can record the user's reaction to the advertisement and calculate the engagement rate. By measuring the effectiveness of the advertisement, the measurement unit enables improvement of the advertisement. Some or all of the above-described processing in the measurement unit may be performed using AI or without using AI. For example, the measurement unit may use an AI model for measuring the effectiveness of the advertisement, using the effectiveness of the advertisement as input, to measure the effectiveness of the advertisement. Specifically, the measurement unit collects time-series data such as advertisement display events (ad ID, display timestamp, display position, device information), click events (click timestamp, user ID, ad ID), and conversion events (purchase completion, membership registration, app installation, etc.), and stores them in a database. The measurement unit aggregates these event data and calculates indicators such as click-through rate (CTR=number of clicks/number of displays), conversion rate (CVR=number of conversions/number of clicks), and engagement rate (e.g., number of comments or shares on the advertisement/number of displays). When using an AI model, the measurement unit inputs advertisement effectiveness data (e.g., time-series vectors of CTR for the past 30 days, user attribute vectors, one-hot vectors for ad types) and performs anomaly detection (e.g., detection of sudden drops in CTR), effectiveness prediction (e.g., predicted CTR for next week: 0.12, predicted CVR: 0.03), and automatic A/B test analysis (e.g., effect of variant A: 0.15, effect of variant B: 0.18). Examples of AI model output include “Ad ID:12345, CTR: 0.12, CVR: 0.03, anomaly flag: False,” “A/B test recommendation: variant B,” etc. Based on these outputs, the measurement unit provides feedback to advertisers and the advertisement selection unit, supporting automatic optimization of advertisement creatives and delivery strategies. Unlike conventional simple aggregation processing, the measurement unit of the present invention combines AI-based time-series analysis, anomaly detection, effectiveness prediction, and automatic A/B test analysis to achieve technical effects such as improved accuracy, real-time performance, and automation of advertisement effectiveness measurement. The applicable fields include online advertisement platforms, SNS advertisements, video advertisements, in-app advertisements, and can be deployed as a basis for measuring the effectiveness of any digital advertisement.

The analysis unit can analyze chat content using natural language processing technology and extract topics and keywords from the conversation. The analysis unit analyzes the chat content using, for example, natural language processing technology. Natural language processing technology includes morphological analysis, grammatical analysis, semantic analysis, and the like. For example, the analysis unit divides words in the chat content using morphological analysis, analyzes sentence structure using grammatical analysis, and understands sentence meaning using semantic analysis. Thus, the analysis unit can analyze chat content using natural language processing technology and extract topics and keywords from the conversation. Some or all of the above-described processing in the analysis unit may be performed using AI or without using AI. For example, the analysis unit may use an AI model for extracting topics and keywords, using chat content as input, to extract topics and keywords. Specifically, the analysis unit receives various data types as chat content, such as UTF-8 encoded string arrays (e.g., “I want to go out somewhere on the weekend,” “I'm looking for a new restaurant”), WAV format audio data sampled at 16 kHz (e.g., 5 seconds of audio), and JPEG or PNG format images (e.g., photos of tourist spots). The analysis unit performs preprocessing on these input data, including noise removal, tokenization, conversion of speech to text (speech recognition), and feature extraction from images (CNN-based image encoder). Next, as the natural language processing unit, the analysis unit utilizes a large-scale language model based on the Transformer architecture to perform morphological analysis (e.g., MeCab algorithm), grammatical analysis (dependency parsing), and semantic analysis (contextual embedding using BERT or RoBERTa) in stages. Examples of input to the AI model include text such as “I want to go out somewhere on the weekend,” or multimodal data such as “photo of a restaurant” plus “voice conversation with a friend.” The analysis unit outputs keywords such as “weekend,” “go out,” “restaurant,” and topic labels such as “travel,” “meal” in the form of probability distributions (e.g., travel 0.85, meal 0.10, shopping 0.05). Internally, the AI model tokenizes the input text, converts it into high-dimensional vectors in the embedding layer, and extracts context-dependent features using a self-attention mechanism. For audio data, acoustic features (MFCC or spectrogram) are extracted and converted to text using a speech recognition model (e.g., RNN or Transformer-based). For image data, a CNN-based image encoder generates feature maps, and an image captioning model converts them into text information. These multimodal features are integrated and finally input to a fully connected layer for keyword extraction and topic classification. Examples of AI model output include “Keywords: weekend, go out, restaurant,” “Topic distribution: travel 0.85, meal 0.10, shopping 0.05,” etc. As a subsequent process, the extracted keywords and topic labels are transferred to the advertisement selection unit and used as input for relevance calculation and personalized recommendation of advertisement candidates. Unlike conventional simple keyword matching or manual analysis, the analysis unit of the present invention achieves technical effects such as significantly improved analysis accuracy, processing speed, and scalability by realizing semantic similarity calculation in high-dimensional vector space and integrated analysis of multimodal data. The applicable fields are not limited to messenger applications but can be expanded to any user-interactive information service, such as SNS, email clients, voice assistants, and IoT device conversation analysis.

The selection unit can select advertisements based on extracted keywords, considering the user's past behavioral history and interests. The selection unit selects advertisements based on extracted keywords, for example. The selection unit may also select advertisements by considering the user's past behavioral history and interests. For example, the selection unit preferentially displays advertisements for leisure spots to users who have previously searched for information about leisure spots. By considering the user's behavioral history and interests, the selection unit can improve the accuracy of advertisement selection. Some or all of the above-described processing in the selection unit may be performed using AI or without using AI. For example, the selection unit may use an AI model for selecting advertisements, using extracted keywords and the user's behavioral history as input, to select advertisements. Specifically, the selection unit receives keywords from the analysis unit (e.g., string arrays such as “weekend,” “go out,” “restaurant”) and the user's behavioral history (e.g., search query vectors for the past 30 days, time-series arrays of click history, interest cluster IDs) as input data. The selection unit inputs these data into advertisement selection AI models such as multi-layer perceptrons or gradient boosting decision trees and calculates relevance scores for each advertisement candidate (e.g., leisure spot advertisement 0.92, restaurant advertisement 0.75, shopping advertisement 0.30). Internally, the AI model vectorizes the keywords and behavioral history, integrates them in a feature combination layer, performs nonlinear transformation through multiple hidden layers, and finally outputs relevance scores for each advertisement. Examples of AI model input include “Keywords: weekend, go out,” “Behavioral history: search query vector [0.12, 0.85, 0.03], click history [Ad ID:12345, time: 2024, Jun. 1 12:00],” etc. Examples of AI model output include “Ad ID:12345, relevance: 0.92,” “Ad ID:67890, relevance: 0.75,” etc. The selection unit selects the most relevant advertisement based on these scores and transfers it to the display unit. As a subsequent process, the selected advertisements are rendered by the display unit, and click events and display counts are sent to the effectiveness measurement unit. Unlike conventional simple rule-based selection or manual advertisement selection, the selection unit of the present invention achieves technical effects such as significantly improved personalization accuracy, selection speed, and operational efficiency by automating the integration of high-dimensional features and time-series analysis of user behavior using AI. The applicable fields include online advertisement platforms, SNS advertisements, video advertisements, in-app advertisements, and can be deployed for personalized advertisement delivery in general.

The display unit can display the selected advertisements in advertisement slots within the messenger application. The display unit displays advertisements in advertisement slots within the messenger application, for example. Advertisement slots may include banner advertisements, text advertisements, video advertisements, and the like, but are not limited thereto. For example, the display unit may display banner advertisements at the top of the chat screen. The display unit may also display text advertisements at the bottom of the chat screen. Furthermore, the display unit may display video advertisements at the center of the chat screen. By appropriately displaying the selected advertisements, the display unit can provide useful information to the user. Some or all of the above-described processing in the display unit may be performed using AI or without using AI. For example, the display unit may use an AI model for displaying advertisements, using the advertisements selected by the selection unit as input, to display the advertisements. Specifically, the display unit receives advertisement data from the selection unit (structured data such as banner image URL, text, video ID, etc.), display position parameters (e.g., top, bottom, center), and HTML/CSS layout information as input data. The display unit inputs these data into an advertisement display AI model (e.g., reinforcement learning-based layout optimization model or rule-based display control module) and determines the optimal display method (e.g., placing banner advertisements at the top, text advertisements at the bottom, and video advertisements at the center). Examples of AI model input include “Ad ID:12345, display position candidate: top, relevance: 0.92,” “Ad ID:67890, display position candidate: bottom, relevance: 0.75,” etc. Examples of AI model output include “Ad ID:12345, display position: top, layout: banner,” “Ad ID:67890, display position: bottom, layout: text,” etc. Based on these outputs, the display unit dynamically renders advertisements in the advertisement slots of the messenger application. As a subsequent process, click events and display counts of advertisements are collected in real time and sent to the advertisement effectiveness measurement unit, which can be used for online learning of the advertisement display algorithm and A/B testing. Unlike conventional static advertisement display or manual layout adjustment, the display unit of the present invention achieves technical effects such as significantly improved effectiveness, user experience, and operational efficiency by realizing dynamic layout optimization and display control according to user behavior using AI. The applicable fields are not limited to messenger applications but can be expanded to any digital advertisement display platform, such as SNS, email clients, video streaming services, and IoT device interfaces.

The analysis unit can estimate the user's emotion and adjust the method of analyzing the chat content based on the estimated emotion of the user. The analysis unit estimates the user's emotion and adjusts the method of analyzing the chat content based on the estimated emotion, for example. Emotion estimation is realized using, for example, an emotion engine or generative AI with emotion estimation functionality. Generative AI may include text generation AI (e.g., LLM) or multimodal generative AI, but is not limited thereto. For example, if the user is excited, the analysis unit uses the emotion engine to preferentially extract positive keywords. If the user is feeling down, the analysis unit uses the emotion engine to preferentially extract negative keywords. Furthermore, if the user is relaxed, the analysis unit uses the emotion engine to preferentially extract neutral keywords. By adjusting the analysis method according to the user's emotion, the analysis unit can improve analysis accuracy. Some or all of the above-described processing in the analysis unit may be performed using AI or without using AI. For example, the analysis unit may use an AI model for adjusting the analysis method, using the user's emotion data as input, to adjust the analysis method. Specifically, the analysis unit receives chat content (UTF-8 encoded string arrays, e.g., “I'm very happy today,” “I've been feeling down lately”), audio data (WAV format sampled at 16 kHz, e.g., 5 seconds of speech), and image data (JPEG/PNG format, e.g., selfies or sticker images) as input data. The analysis unit performs preprocessing on these input data, including noise removal, conversion of speech to text (speech recognition), and extraction of facial expression features from images (CNN-based image encoder). Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05) from the input data. Examples of AI model input include “Text: I'm very happy today,” “Audio: speech with an excited tone,” “Image: smiling face,” etc. Examples of AI model output include “Emotion label: positive, score: 0.85,” “Emotion label: negative, score: 0.70,” etc. The analysis unit dynamically adjusts parameters of the natural language processing unit (e.g., weighting for keyword extraction, context window size, topic classification threshold) based on the estimated emotion information. For example, if positive emotion is strong, affirmative words and recommended words are preferentially extracted; if negative emotion is strong, keywords related to worries and issues are emphasized. As a subsequent process, the adjusted analysis results are transferred to the advertisement selection unit and used for advertisement recommendation and information presentation optimized for the user's emotional state. Unlike conventional uniform analysis methods or manual emotion judgment, the analysis unit of the present invention achieves technical effects such as significantly improved analysis accuracy, user adaptability, and processing efficiency by combining AI-based multimodal emotion estimation and automatic optimization of analysis parameters. The applicable fields include messenger applications, SNS, voice assistants, healthcare chatbots, educational support systems, and can be deployed for any interactive service requiring information analysis and recommendation according to the user's emotional state.

The analysis unit can improve the accuracy of extracting topics and keywords by considering the context of the conversation when analyzing chat content. The analysis unit improves the accuracy of extracting topics and keywords by considering the context of the conversation when analyzing chat content, for example. Context analysis includes the preceding and following conversation content and related topics. For example, the analysis unit can analyze the preceding and following context of the conversation and extract related keywords. The analysis unit can also analyze the flow of the conversation and identify the main topics. Furthermore, the analysis unit can preferentially extract keywords that repeatedly appear in the conversation. By considering the context of the conversation, the analysis unit can improve the accuracy of extracting topics and keywords. Some or all of the above-described processing in the analysis unit may be performed using AI or without using AI. For example, the analysis unit may use an AI model for extracting topics and keywords, using conversation context data as input, to extract topics and keywords. Specifically, the analysis unit receives time-series data of chat content (e.g., arrays of utterance texts for the last 10 turns, timestamps for each utterance, speaker IDs), arrays of topic labels for conversation history (e.g., travel, meal, shopping, etc.), and structured data indicating the flow of the conversation (e.g., dependency graphs between utterances) as input data. The analysis unit performs preprocessing on these input data, including tokenization, segmentation by utterance unit, and extraction of relationships between utterances (e.g., dependency parsing). Next, the analysis unit utilizes large-scale language models based on the Transformer architecture and conversation history encoders (e.g., bidirectional LSTM, conversation-specific BERT) to embed context information of utterances as high-dimensional vectors and uses self-attention mechanisms to extract important utterances and keywords. Examples of AI model input include “Utterance history: ‘Where are we going this weekend?’ ‘I want to go to a hot spring.’ ‘Then let's make a reservation,’” “Topic history: travel, hot spring,” etc. Examples of AI model output include “Extracted keywords: weekend, hot spring, reservation,” “Main topic: travel (0.90), meal (0.05),” etc. The analysis unit dynamically adjusts weighting for keyword extraction and thresholds for topic classification based on the flow of the conversation, frequency of repeated words, and relevance scores between utterances. As a subsequent process, the extracted keywords and topic information are transferred to the advertisement selection unit and used for context-aware advertisement recommendation and information presentation. Unlike conventional simple sentence analysis or keyword frequency extraction, the analysis unit of the present invention achieves technical effects such as significantly improved extraction accuracy, context adaptability, and processing efficiency by combining AI-based time-series context analysis, utterance dependency analysis, and self-attention mechanisms. The applicable fields include messenger applications, SNS, customer support chatbots, educational support systems, and can be deployed for any interactive service requiring context-focused information extraction from conversations.

The analysis unit can analyze chat content by considering attribute information of the participants in the conversation when analyzing chat content. The analysis unit analyzes chat content by considering attribute information of the participants in the conversation, for example. Attribute information includes age, gender, occupation, hobbies, and the like. For example, the analysis unit can extract keywords by considering the age and gender of the participants in the conversation. The analysis unit can also identify topics by considering the occupation and hobbies of the participants. Furthermore, the analysis unit can analyze by referring to the past utterance history of the participants in the conversation. By considering attribute information of the participants in the conversation, the analysis unit can improve analysis accuracy. Some or all of the above-described processing in the analysis unit may be performed using AI or without using AI. For example, the analysis unit may use an AI model for analysis, using attribute information of the participants in the conversation as input, to perform analysis. Specifically, the analysis unit receives structured data such as attribute data for each participant (e.g., age: 35, gender: female, occupation: engineer, hobby: mountain climbing), past utterance history (e.g., arrays of the last 30 utterance texts, topic labels for each utterance), and behavioral patterns for each participant (e.g., utterance frequency, utterance time zone) as input data. The analysis unit performs preprocessing on these input data, including normalization of attribute data, one-hot encoding of categorical variables, and vectorization of time-series utterance history. Next, the analysis unit integrates attribute information and utterance history using AI models such as multi-layer perceptrons or gradient boosting decision trees and performs optimal keyword extraction and topic classification for each attribute. Examples of AI model input include “Attribute: age 35, gender female, hobby mountain climbing,” “Utterance history: ‘I want to go to the mountains next time,’ ‘I want new climbing shoes,’” etc. Examples of AI model output include “Extracted keywords: mountain climbing, shoes, mountain,” “Main topic: outdoor (0.85),” etc. The analysis unit dynamically switches analysis parameters (e.g., vocabulary lists for each age group, topic dictionaries for each hobby) according to attribute information to improve the interpretation of utterance meaning and the accuracy of keyword extraction. As a subsequent process, analysis results optimized for attributes are transferred to the advertisement selection unit and used for personalized advertisement recommendation and information presentation. Unlike conventional uniform analysis or manual attribute judgment, the analysis unit of the present invention achieves technical effects such as significantly improved analysis accuracy, personalization, and processing efficiency by combining AI-based integration of attribute information, history analysis, and automatic optimization of parameters. The applicable fields include messenger applications, SNS, customer support, educational support systems, and can be deployed for any interactive service requiring information analysis and recommendation according to user attributes.

The analysis unit can estimate the user's emotion and adjust the method of displaying the analysis result based on the estimated emotion of the user. The analysis unit estimates the user's emotion and adjusts the method of displaying the analysis result based on the estimated emotion, for example. Emotion estimation is realized using, for example, an emotion engine or generative AI with emotion estimation functionality. Generative AI may include text generation AI (e.g., LLM) or multimodal generative AI, but is not limited thereto. For example, if the user is excited, the analysis unit uses the emotion engine to emphasize positive analysis results in the display. If the user is feeling down, the analysis unit uses the emotion engine to display negative analysis results in a subdued manner. Furthermore, if the user is relaxed, the analysis unit uses the emotion engine to display neutral analysis results in a balanced manner. By adjusting the method of displaying the analysis result according to the user's emotion, the analysis unit enables easy-to-view displays for the user. Some or all of the above-described processing in the analysis unit may be performed using AI or without using AI. For example, the analysis unit may use an AI model for adjusting the display method, using the user's emotion data as input, to adjust the display method. Specifically, the analysis unit receives chat content (UTF-8 encoded string arrays, e.g., “I'm very happy today,” “I've been feeling down lately”), audio data (WAV format sampled at 16 kHz, e.g., 5 seconds of speech), and image data (JPEG/PNG format, e.g., selfies or sticker images) as input data. The analysis unit performs preprocessing on these input data, including noise removal, conversion of speech to text, and extraction of facial expression features from images. Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05). Examples of AI model input include “Text: I'm very happy today,” “Audio: speech with an excited tone,” “Image: smiling face,” etc. Examples of AI model output include “Emotion label: positive, score: 0.85,” “Emotion label: negative, score: 0.70,” etc. The analysis unit dynamically adjusts display parameters for the analysis result (e.g., highlight color, font size, display order, display frequency) based on the estimated emotion information. For example, if positive emotion is strong, affirmative analysis results are displayed in prominent colors or large fonts; if negative emotion is strong, negative analysis results are displayed in subdued colors or small fonts. As a subsequent process, the adjusted display results are rendered in the user interface, contributing to optimization of user experience and stress reduction. Unlike conventional uniform display or manual emotion judgment, the analysis unit of the present invention achieves technical effects such as significantly improved display adaptability, user satisfaction, and processing efficiency by combining AI-based multimodal emotion estimation and automatic optimization of display parameters. The applicable fields include messenger applications, SNS, healthcare chatbots, educational support systems, and can be deployed for any interactive service requiring information display according to the user's emotional state.

The analysis unit can analyze chat content by considering the geographical background of the conversation when analyzing chat content. The analysis unit analyzes chat content by considering the geographical background of the conversation, for example. Geographical background includes regional culture, climate, events, and the like. For example, the analysis unit can identify place names or locations mentioned in the conversation and extract related keywords. The analysis unit can also identify topics by considering the location information of the participants in the conversation. Furthermore, the analysis unit can adjust the analysis result based on the geographical background mentioned in the conversation. By considering the geographical background of the conversation, the analysis unit can improve analysis accuracy. Some or all of the above-described processing in the analysis unit may be performed using AI or without using AI. For example, the analysis unit may use an AI model for analysis, using geographical background data as input, to perform analysis. Specifically, the analysis unit receives chat content (UTF-8 encoded string arrays, e.g., “I want to go to the snow festival in Sapporo,” “Let's go to the beach in Okinawa”), location information data (GPS coordinates, IP address, region ID from location information services), and regional attribute data (e.g., climate classification, regional event calendar, cultural characteristics) as input data. The analysis unit performs preprocessing on these input data, including place name extraction (named entity recognition algorithm), normalization of location information, and mapping of regional attributes. Next, a natural language processing AI model that considers geographical background (e.g., BERT with geographical information embedding, multi-layer perceptron using regional attributes as features) extracts keywords and classifies topics related to place names and locations. Examples of AI model input include “Text: I want to go to the snow festival in Sapporo,” “Location information: Sapporo, Hokkaido,” “Regional attribute: winter event,” etc. Examples of AI model output include “Extracted keywords: snow festival, Sapporo, winter,” “Main topic: event (0.90), travel (0.80),” etc. The analysis unit dynamically adjusts analysis parameters (e.g., topic dictionaries for each region, keyword weighting based on climate and events) according to geographical background to accurately extract region-specific topics and expressions. As a subsequent process, analysis results reflecting geographical background are transferred to the advertisement selection unit and used for recommending region-specific advertisements and local event information. Unlike conventional analysis that does not consider geographical information or manual region judgment, the analysis unit of the present invention achieves technical effects such as significantly improved analysis accuracy, regional adaptability, and processing efficiency by combining AI-based integration of geographical information, regional attribute analysis, and automatic optimization of parameters. The applicable fields include messenger applications, SNS, tourism information services, regional event guide systems, and can be deployed for any interactive service requiring information analysis and recommendation focused on geographical background.

The analysis unit can improve the accuracy of analysis by referring to related literature of the conversation when analyzing chat content. The analysis unit improves the accuracy of analysis by referring to related literature of the conversation when analyzing chat content, for example. Related literature includes academic papers, technical reports, news articles, and the like. For example, the analysis unit can refer to literature related to topics mentioned in the conversation and extract keywords. The analysis unit can also refer to research papers related to topics mentioned in the conversation and perform analysis. Furthermore, the analysis unit can refer to news articles related to topics mentioned in the conversation and perform analysis. By referring to related literature, the analysis unit can improve analysis accuracy. Some or all of the above-described processing in the analysis unit may be performed using AI or without using AI. For example, the analysis unit may use an AI model for analysis, using related literature data as input, to perform analysis. Specifically, the analysis unit receives chat content (UTF-8 encoded string arrays, e.g., “I want to know about quantum computers,” “What are the recent advances in AI technology?”), related literature databases (titles, abstracts, and keywords of academic papers, full text of technical reports, body text of news articles), and topic labels (e.g., quantum computing, natural language processing, image recognition) as input data. The analysis unit performs preprocessing on these input data, including topic extraction, literature search (BM25 or Dense Passage Retrieval), and keyword matching. Next, a natural language processing AI model that refers to related literature (e.g., Retriever-Reader structured large-scale language model, BERT-based model using literature embeddings) integratively analyzes the chat content and the content of related literature, and performs specialized keyword extraction and topic classification. Examples of AI model input include “Text: I want to know about quantum computers,” “Related literature: latest trends in quantum algorithms (paper abstract),” etc. Examples of AI model output include “Extracted keywords: qubit, superconducting circuit,” “Main topic: quantum computing (0.95),” etc. The analysis unit dynamically adjusts analysis parameters (e.g., specialized term dictionaries, weights of topic classification models) based on the content of related literature to realize analysis reflecting the latest knowledge and specialized information. As a subsequent process, literature-referenced analysis results are transferred to the advertisement selection unit and information recommendation unit and used for recommending highly specialized advertisements and information presentation. Unlike conventional analysis without literature reference or manual information search, the analysis unit of the present invention achieves technical effects such as significantly improved analysis accuracy, specialization, and information coverage by combining AI-based literature search, content integration, and automatic optimization of parameters. The applicable fields include messenger applications, expert chatbots, educational support systems, technical information services, and can be deployed for any interactive service requiring literature-referenced information analysis.

The selection unit can estimate the user's emotion and adjust the criteria for selecting advertisements based on the estimated emotion of the user. The selection unit estimates the user's emotion and adjusts the criteria for selecting advertisements based on the estimated emotion, for example. Emotion estimation is realized using, for example, an emotion engine or generative AI with emotion estimation functionality. Generative AI may include text generation AI (e.g., LLM) or multimodal generative AI, but is not limited thereto. For example, if the user is excited, the selection unit uses the emotion engine to preferentially select positive advertisements. If the user is feeling down, the selection unit uses the emotion engine to preferentially select encouraging advertisements. Furthermore, if the user is relaxed, the selection unit uses the emotion engine to preferentially select neutral advertisements. By adjusting the criteria for selecting advertisements according to the user's emotion, the selection unit can select more appropriate advertisements. Some or all of the above-described processing in the selection unit may be performed using AI or without using AI. For example, the selection unit may use an AI model for adjusting the criteria for selecting advertisements, using the user's emotion data as input, to adjust the criteria for selecting advertisements. Specifically, the selection unit receives emotion labels (e.g., positive, negative, neutral) and emotion scores (e.g., joy 0.80, sadness 0.10, anger 0.05, surprise 0.05) output from the emotion estimation AI model as input data. The emotion estimation AI model estimates these from chat content (UTF-8 encoded string arrays, e.g., “I'm very happy today,” “I've been feeling down lately”), audio data (WAV format sampled at 16 kHz, e.g., 5 seconds of speech), and image data (JPEG/PNG format, e.g., selfies or sticker images) after preprocessing for noise removal, speech recognition, and image feature extraction, using a BERT-based emotion classification model, ResNet-based facial expression recognition model, or RNN-based emotion estimation model using acoustic features. Examples of AI model input include “Text: I'm very happy today,” “Audio: speech with an excited tone,” “Image: smiling face,” etc. Examples of AI model output include “Emotion label: positive, score: 0.85,” “Emotion label: negative, score: 0.70,” etc. The selection unit inputs these emotion information as additional features to the advertisement selection AI model (multi-layer perceptron or gradient boosting decision tree) and calculates emotion suitability scores for each advertisement candidate (e.g., positive advertisement 0.90, encouraging advertisement 0.85, neutral advertisement 0.60). The selection unit combines the emotion suitability score with conventional relevance scores (e.g., scores based on behavioral history and keywords) by weighting, and dynamically adjusts the final criteria for selecting advertisements. Examples of AI model output include “Ad ID:12345, emotion suitability: 0.90, total score: 0.95,” “Ad ID:67890, emotion suitability: 0.60, total score: 0.70,” etc. As a subsequent process, the selected advertisements are transferred to the display unit, and advertisements optimized for the user's emotional state are displayed. Unlike conventional uniform advertisement selection or manual emotion judgment, the selection unit of the present invention achieves technical effects such as significantly improved personalization accuracy, user experience, and advertisement effectiveness by combining AI-based multimodal emotion estimation and automatic optimization of advertisement selection criteria. The applicable fields include messenger applications, SNS, healthcare chatbots, educational support systems, and can be deployed for any interactive service requiring advertisement recommendation according to the user's emotional state.

The selection unit can optimize the selection algorithm by referring to past advertisement effectiveness data when selecting advertisements. The selection unit optimizes the selection algorithm by referring to past advertisement effectiveness data when selecting advertisements, for example. Advertisement effectiveness data includes past click-through rates, conversion rates, engagement rates, and the like. For example, the selection unit can select effective advertisements based on past advertisement click-through rates. The selection unit can also select optimal advertisements based on past advertisement display counts and conversion rates. Furthermore, the selection unit can analyze past advertisement effectiveness data and select the most effective advertisements. By referring to past advertisement effectiveness data, the selection unit can optimize the selection algorithm. Some or all of the above-described processing in the selection unit may be performed using AI or without using AI. For example, the selection unit may use an AI model for optimizing the selection algorithm, using past advertisement effectiveness data as input, to optimize the selection algorithm. Specifically, the selection unit receives time-series data collected from the advertisement effectiveness measurement unit, such as past advertisement display events (ad ID, display timestamp, display position, device information), click events (click timestamp, user ID, ad ID), and conversion events (purchase completion, membership registration, app installation, etc.) as input data. These data are aggregated as indicators such as click-through rate (CTR), conversion rate (CVR), and engagement rate (e.g., number of comments or shares/number of displays). The selection unit inputs these indicators as feature vectors (e.g., time-series vectors of CTR for the past 30 days, one-hot vectors for ad types, user attribute vectors) to AI models (e.g., gradient boosting decision tree, random forest, LSTM-based time-series prediction model) and calculates future effectiveness prediction scores for each advertisement candidate (e.g., predicted CTR 0.12, predicted CVR 0.03, predicted engagement 0.15). Examples of AI model input include “Ad ID:12345, past CTR: [0.10, 0.12, 0.11], CVR: [0.02, 0.03, 0.025],” “Ad ID:67890, past CTR: [0.08, 0.09, 0.10], CVR: [0.01, 0.015, 0.02],” etc. Examples of AI model output include “Ad ID:12345, predicted CTR: 0.13, predicted CVR: 0.035,” “Ad ID:67890, predicted CTR: 0.11, predicted CVR: 0.025,” etc. The selection unit prioritizes selection of advertisements predicted to be most effective based on these prediction scores and transfers them to the display unit. As a subsequent process, the selection results are fed back to the advertisement effectiveness measurement unit and used for continuous optimization of the algorithm through online learning and A/B testing. Unlike conventional static rule-based selection or manual effectiveness analysis, the selection unit of the present invention achieves technical effects such as significantly improved selection accuracy, operational efficiency, and advertisement effectiveness by combining AI-based time-series effectiveness prediction and automatic optimization of the algorithm. The applicable fields include online advertisement platforms, SNS advertisements, video advertisements, in-app advertisements, and can be deployed for any digital advertisement delivery platform requiring optimization based on effectiveness data.

The selection unit can select advertisements by taking into account the user's current interests and living conditions when selecting advertisements. The selection unit selects advertisements by taking into account the user's current interests and living conditions when selecting advertisements, for example. Interests include recent search history, social media post content, and the like. For example, the selection unit can select advertisements of interest based on the user's current search history. The selection unit can also analyze the user's current social media activity and select related advertisements. Furthermore, the selection unit can select advertisements by considering the user's current living conditions (e.g., traveling, moving, etc.). By taking into account the user's current interests and living conditions, the selection unit can select more relevant advertisements. Some or all of the above-described processing in the selection unit may be performed using AI or without using AI. For example, the selection unit may use an AI model for selecting advertisements, using the user's interests and living condition data as input, to select advertisements. Specifically, the selection unit receives various data types as input data, such as the user's recent search history (search query string arrays, search timestamp), social media post content (post text, image URL, post timestamp), and living condition data (calendar events, location information, status data from IoT devices). The selection unit performs preprocessing on these data, including tokenization, category classification, and time-series vectorization, and extracts features using large-scale language models based on the Transformer architecture or multimodal encoders. Examples of AI model input include “Search history: ‘moving company,’ ‘new home furniture,’” “Post content: ‘traveling in Okinawa,’ ‘went to a new cafe,’” “Living condition: calendar event ‘travel,’” etc. The AI model integrates these features and estimates the user's current interest topics (e.g., travel, moving, cafe) and living condition labels (e.g., traveling, moving). Examples of AI model output include “Interest topic: travel (0.85), moving (0.75),” “Living condition: traveling,” etc. The selection unit calculates relevance scores for each advertisement candidate (e.g., travel advertisement 0.92, moving advertisement 0.88, cafe advertisement 0.80) based on these estimation results and selects the most relevant advertisements. As a subsequent process, the selection results are transferred to the display unit, and advertisements optimized for the user's current situation are displayed. Unlike conventional static attribute-based selection or manual interest estimation, the selection unit of the present invention achieves technical effects such as significantly improved personalization accuracy, real-time performance, and user experience by combining AI-based integration of time-series and multimodal data, interest estimation, and living condition recognition. The applicable fields include messenger applications, SNS, EC sites, life log services, and can be deployed for any interactive service requiring situation-adaptive advertisement recommendation for users.

The selection unit can estimate the user's emotion and adjust the display order of advertisements based on the estimated emotion of the user. The selection unit estimates the user's emotion and adjusts the display order of advertisements based on the estimated emotion, for example. Emotion estimation is realized using, for example, an emotion engine or generative AI with emotion estimation functionality. Generative AI may include text generation AI (e.g., LLM) or multimodal generative AI, but is not limited thereto. For example, if the user is excited, the selection unit uses the emotion engine to display positive advertisements first. If the user is feeling down, the selection unit uses the emotion engine to display encouraging advertisements first. Furthermore, if the user is relaxed, the selection unit uses the emotion engine to display neutral advertisements first. By adjusting the display order of advertisements according to the user's emotion, the selection unit enables more effective advertisement display. Some or all of the above-described processing in the selection unit may be performed using AI or without using AI. For example, the selection unit may use an AI model for adjusting the display order of advertisements, using the user's emotion data as input, to adjust the display order of advertisements. Specifically, the selection unit receives emotion labels (e.g., positive, negative, neutral) and emotion scores (e.g., joy 0.80, sadness 0.10, anger 0.05, surprise 0.05) output from the emotion estimation AI model as input data. The emotion estimation AI model estimates these from chat content (UTF-8 encoded string arrays, e.g., “I'm very happy today,” “I've been feeling down lately”), audio data (WAV format sampled at 16 kHz, e.g., 5 seconds of speech), and image data (JPEG/PNG format, e.g., smiling photos) after preprocessing for noise removal, speech recognition, and image feature extraction, using a BERT-based emotion classification model, ResNet-based facial expression recognition model, or RNN-based emotion estimation model using acoustic features. Examples of AI model input include “Text: I'm very happy today,” “Audio: speech with an excited tone,” “Image: smiling face,” etc. Examples of AI model output include “Emotion label: positive, score: 0.85,” “Emotion label: negative, score: 0.70,” etc. The selection unit calculates emotion suitability scores for each advertisement candidate (e.g., positive advertisement 0.90, encouraging advertisement 0.85, neutral advertisement 0.60) based on these emotion information and prioritizes advertisements with higher emotion suitability scores in the display order. Examples of AI model output include “Ad ID:12345, display order: 1, emotion suitability: 0.90,” “Ad ID:67890, display order: 2, emotion suitability: 0.85,” etc. As a subsequent process, the adjusted advertisement display order is transferred to the display unit, and advertisements optimized for the user's emotional state are displayed. Unlike conventional static display order or manual emotion judgment, the selection unit of the present invention achieves technical effects such as significantly improved effectiveness of advertisement display, user experience, and advertisement effectiveness by combining AI-based multimodal emotion estimation and automatic optimization of display order. The applicable fields include messenger applications, SNS, healthcare chatbots, educational support systems, and can be deployed for any interactive service requiring control of advertisement display order according to the user's emotional state.

The selection unit can prioritize the selection of highly relevant advertisements by taking into account the user's geographical location information when selecting advertisements. The selection unit prioritizes the selection of highly relevant advertisements by taking into account the user's geographical location information when selecting advertisements, for example. Geographical location information includes GPS data, IP address, location information services, and the like. For example, the selection unit can select advertisements for nearby stores or services based on the user's current location. The selection unit can also select regional campaign advertisements based on the user's location information. Furthermore, the selection unit can select advertisements for local events or activities by considering the user's location information. By taking into account the user's geographical location information, the selection unit can select highly relevant advertisements. Some or all of the above-described processing in the selection unit may be performed using AI or without using AI. For example, the selection unit may use an AI model for selecting advertisements, using the user's geographical location information as input, to select advertisements. Specifically, the selection unit receives structured data such as the user's current location information (GPS coordinates, IP address, region ID from location information services), regional attribute data (e.g., climate classification, regional event calendar, cultural characteristics), and past location history (e.g., list of regions visited in the past 30 days) as input data. The selection unit performs preprocessing on these data, including place name extraction, normalization of location information, and mapping of regional attributes, and inputs them into AI models such as BERT with geographical information embedding or multi-layer perceptron. Examples of AI model input include “Location information: Shinjuku, Tokyo,” “Regional attribute: urban area, event: summer festival,” etc. The AI model calculates region suitability scores for each advertisement candidate (e.g., nearby store advertisement 0.95, regional campaign advertisement 0.90, local event advertisement 0.85) based on these features. Examples of AI model output include “Ad ID:12345, region suitability: 0.95,” “Ad ID:67890, region suitability: 0.90,” etc. The selection unit prioritizes advertisements with higher region suitability scores and transfers them to the display unit. As a subsequent process, the selection results are fed back to the advertisement effectiveness measurement unit and used for region-specific advertisement effectiveness analysis and optimization of delivery strategies. Unlike conventional advertisement selection that does not consider geographical information or manual region judgment, the selection unit of the present invention achieves technical effects such as significantly improved regional adaptability, selection accuracy, and operational efficiency by combining AI-based integration of geographical information, regional attribute analysis, and automatic optimization. The applicable fields include messenger applications, SNS, tourism information services, regional event guide systems, and can be deployed for any interactive service requiring advertisement recommendation focused on geographical background.

The selection unit can select relevant advertisements by analyzing the user's social media activity when selecting advertisements. The selection unit selects relevant advertisements by analyzing the user's social media activity when selecting advertisements, for example. Social media activity includes post content, number of likes, number of followers, and the like. For example, the selection unit can select relevant advertisements based on the user's history of likes and shares on social media. The selection unit can also select relevant advertisements based on the accounts followed by the user on social media. Furthermore, the selection unit can analyze the user's post content on social media and select relevant advertisements. By analyzing the user's social media activity, the selection unit can select highly relevant advertisements. Some or all of the above-described processing in the selection unit may be performed using AI or without using AI. For example, the selection unit may use an AI model for selecting advertisements, using the user's social media activity data as input, to select advertisements. Specifically, the selection unit receives structured data such as the user's social media post content (text, image URL, post timestamp), history of likes and shares (post ID, action type, action timestamp), and list of followed accounts (account ID, category, follow timestamp) as input data. The selection unit performs preprocessing on these data, including tokenization, category classification, and time-series vectorization, and extracts features using large-scale language models based on the Transformer architecture or graph neural networks. Examples of AI model input include “Post content: ‘Went to a new cafe,’ ‘Uploaded travel photos,’” “Like history: cafe post, travel post,” “Followed accounts: gourmet, travel,” etc. The AI model integrates these features, estimates the user's current interest topics and activity tendencies, and calculates relevance scores for each advertisement candidate (e.g., cafe advertisement 0.92, travel advertisement 0.88, gourmet advertisement 0.85). Examples of AI model output include “Ad ID:12345, relevance: 0.92,” “Ad ID:67890, relevance: 0.88,” etc. The selection unit prioritizes advertisements with higher relevance scores and transfers them to the display unit. As a subsequent process, the selection results are fed back to the advertisement effectiveness measurement unit and used for correlation analysis between social media activity and advertisement effectiveness and optimization of delivery strategies. Unlike conventional static attribute-based selection or manual interest estimation, the selection unit of the present invention achieves technical effects such as significantly improved personalization accuracy, real-time performance, and advertisement effectiveness by combining AI-based social media activity analysis, graph structure analysis, and automatic optimization. The applicable fields include messenger applications, SNS, EC sites, life log services, and can be deployed for any interactive service requiring social media-linked advertisement recommendation.

The display unit can estimate the user's emotion and adjust the method of displaying advertisements based on the estimated emotion of the user. For example, the display unit estimates the user's emotion and adjusts the advertisement display method according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the display unit uses the emotion engine to prominently display positive advertisements. When the user is feeling down, the display unit can use the emotion engine to discreetly display encouraging advertisements. Furthermore, when the user is relaxed, the display unit can use the emotion engine to display neutral advertisements in a balanced manner. By adjusting the advertisement display method according to the user's emotion, the display unit enables more effective advertisement presentation. Some or all of the above-described processing in the display unit may be performed using AI or without AI. For example, the display unit can adjust the advertisement display method by inputting the user's emotion data into an AI model that adjusts the advertisement display method. Specifically, the display unit receives input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The display unit performs preprocessing on these input data, such as noise removal, speech-to-text conversion (speech recognition), and facial expression feature extraction from images (CNN-based image encoder). Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05) from the input data. Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the display unit dynamically adjusts advertisement display parameters (e.g., highlight color, font size, animation effect, display position, display frequency). For example, when positive emotion is strong, affirmative advertisements are displayed with bright colors, large fonts, and animation effects. When negative emotion is strong, encouraging advertisements are displayed with subdued colors, small fonts, and positioned at the corner of the screen. For neutral emotion, multiple advertisements are arranged in a balanced manner, and display frequency and emphasis are equalized. Examples of AI model output include “Ad ID:12345, display method: highlight color #FFCC00, font size: 24 px, animation: bounce”, “Ad ID:67890, display method: grayscale, font size: 14 px, position: bottom right”. Subsequently, the adjusted advertisement display is rendered on the user interface, and click events and display counts are sent to the advertisement effectiveness measurement unit. This enables real-time optimization of advertisement effectiveness and user experience. Unlike conventional uniform advertisement display or manual emotion judgment, the present display unit combines AI-based multimodal emotion estimation and automatic optimization of display parameters, resulting in significant improvements in display adaptability, user satisfaction, advertisement effectiveness, and processing efficiency. Applicable fields include messenger applications, SNS, healthcare chatbots, educational support systems, e-commerce sites, video streaming services, and all interactive services requiring information display adapted to the user's emotional state.

The display unit can select the optimal display method by referring to the user's past advertisement click history when displaying advertisements. For example, the display unit selects the optimal display method by referring to the user's past advertisement click history when displaying advertisements. Advertisement click history includes past click data, click-through rates, and so on. For instance, the display unit can adopt a display method similar to that of advertisements the user has previously clicked. The display unit can also analyze the user's past advertisement click history to select the most effective display method. Furthermore, the display unit can prioritize the display of related advertisements based on the user's past advertisement click history. By referring to the user's past advertisement click history, the display unit can select the optimal display method. Some or all of the above-described processing in the display unit may be performed using AI or without AI. For example, the display unit can select the display method by inputting the user's advertisement click history data into an AI model that selects the display method. Specifically, the display unit receives input data such as the user's advertisement click history (e.g., advertisement ID, click date and time, display method ID, device information, display position, advertisement type), click-through rate (CTR), number of displays, conversion rate (CVR), and other structured data. The display unit performs preprocessing on these data, such as time-series vectorization, one-hot encoding of categorical variables, and feature extraction. Next, a display method optimization AI model (e.g., gradient boosting decision tree, random forest, LSTM-based time-series prediction model) calculates display method scores for each advertisement candidate (e.g., banner display 0.85, video display 0.75, text display 0.60) and display position scores (e.g., top 0.90, bottom 0.70). Examples of input to the AI model include “Ad ID:12345, past click history: [banner top, 2024 Jun. 1 12:00]”, “Ad ID:67890, past click history: [video center, 2024, Jun. 2 18:00]”. Examples of output from the AI model include “Ad ID:12345, recommended display method: banner top, score: 0.92”, “Ad ID:67890, recommended display method: video center, score: 0.88”. Based on these recommendations, the display unit dynamically determines the advertisement display method (layout, display position, display format) and renders it on the user interface. Subsequently, click events and display counts of the display results are sent to the advertisement effectiveness measurement unit and used for algorithm optimization through online learning and A/B testing. Unlike conventional static display methods or manual history analysis, the present display unit combines AI-based time-series history analysis, display method optimization, and automatic learning, resulting in significant improvements in advertisement display personalization accuracy, effectiveness, and operational efficiency. Applicable fields include messenger applications, SNS, e-commerce sites, video streaming services, in-app advertisements, and all interactive services requiring advertisement display optimization based on user history.

The display unit can customize the display method by considering the user's device information when displaying advertisements. For example, the display unit customizes the display method by considering the user's device information when displaying advertisements. Device information includes device type, OS, browser, and so on. For instance, when the user is using a smartphone, the display unit can provide an advertisement display method optimized for the screen size. When the user is using a tablet, the display unit can provide an advertisement display method optimized for a larger screen. Furthermore, when the user is using a desktop, the display unit can provide an advertisement display method optimized for a wide screen. By considering the user's device information, the display unit can provide the optimal display method. Some or all of the above-described processing in the display unit may be performed using AI or without AI. For example, the display unit can customize the display method by inputting the user's device information into an AI model that customizes the display method. Specifically, the display unit receives input data such as the user's device information (e.g., device type: smartphone, tablet, desktop; OS version; screen resolution; browser type; application ID). The display unit performs preprocessing on these data, such as one-hot encoding of categorical variables, numerical normalization, and feature extraction. Next, a device optimization AI model (e.g., multilayer perceptron, decision tree, rule-based optimization module) estimates optimal advertisement display parameters for each device environment (e.g., layout type, image size, font size, interaction method). Examples of input to the AI model include “Device: smartphone, screen resolution: 1080×1920”, “Device: tablet, screen resolution: 2048×1536”, “Device: desktop, screen resolution: 2560×1440”. Examples of output from the AI model include “Display method: banner (horizontal), image size: 320×100, font size: 16 px”, “Display method: video (center), image size: 800×600, font size: 24 px”. Based on these estimation results, the display unit automatically switches the advertisement layout and display format and renders advertisements optimized for the user interface. Subsequently, click events and display counts of the display results are sent to the advertisement effectiveness measurement unit and used for device-specific advertisement effectiveness analysis and continuous optimization of display methods. Unlike conventional uniform advertisement display or manual device determination, the present display unit combines AI-based device information analysis and automatic optimization of display parameters, resulting in significant improvements in advertisement display adaptability, user experience, advertisement effectiveness, and operational efficiency. Applicable fields include messenger applications, SNS, e-commerce sites, video streaming services, IoT device interfaces, and all interactive services requiring multi-device compatible advertisement display.

The display unit can estimate the user's emotion and adjust the frequency of displaying advertisements based on the estimated emotion of the user. For example, the display unit estimates the user's emotion and adjusts the advertisement display frequency according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the display unit uses the emotion engine to increase the frequency of positive advertisements. When the user is feeling down, the display unit can use the emotion engine to increase the frequency of encouraging advertisements. Furthermore, when the user is relaxed, the display unit can use the emotion engine to adjust the frequency of neutral advertisements. By adjusting the advertisement display frequency according to the user's emotion, the display unit enables more effective advertisement presentation. Some or all of the above-described processing in the display unit may be performed using AI or without AI. For example, the display unit can adjust the advertisement display frequency by inputting the user's emotion data into an AI model that adjusts the advertisement display frequency. Specifically, the display unit receives input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The display unit performs preprocessing on these input data, such as noise removal, speech-to-text conversion, and facial expression feature extraction from images. Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05). Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the display unit dynamically adjusts advertisement-specific display frequency parameters (e.g., number of displays per minute, consecutive display restrictions for the same advertisement, display ratio by advertisement type). For example, when positive emotion is strong, the frequency of affirmative advertisements is increased; when negative emotion is strong, the frequency of encouraging advertisements is increased; and for neutral emotion, the display frequency of all advertisement types is equalized. Examples of AI model output include “Ad ID:12345, display frequency: 5 times/min”, “Ad ID:67890, display frequency: 2 times/min”. Subsequently, the adjusted advertisement display frequency is reflected in the user interface, and click events and display counts are sent to the advertisement effectiveness measurement unit. Unlike conventional uniform display frequency or manual emotion judgment, the present display unit combines AI-based multimodal emotion estimation and automatic optimization of display frequency, resulting in significant improvements in advertisement display effectiveness, user experience, advertisement effectiveness, and operational efficiency. Applicable fields include messenger applications, SNS, healthcare chatbots, educational support systems, e-commerce sites, video streaming services, and all interactive services requiring advertisement display frequency control adapted to the user's emotional state.

The display unit can select the optimal display method by considering the user's geographical location information when displaying advertisements. For example, the display unit selects the optimal display method by considering the user's geographical location information when displaying advertisements. Geographical location information includes GPS data, IP address, location information services, and so on. For instance, the display unit can display advertisements for nearby stores or services based on the user's current location. The display unit can also display region-specific campaign advertisements based on the user's location information. Furthermore, the display unit can display advertisements for local events or activities by considering the user's location information. By considering the user's geographical location information, the display unit can provide the optimal display method. Some or all of the above-described processing in the display unit may be performed using AI or without AI. For example, the display unit can select the display method by inputting the user's geographical location information into an AI model that selects the display method. Specifically, the display unit receives input data such as the user's current location information (GPS coordinates, IP address, region ID from location information services), regional attribute data (e.g., climate zone, regional event calendar, cultural characteristics), and past location history (e.g., list of visited regions in the past 30 days) as structured data. The display unit performs preprocessing on these data, such as place name extraction, normalization of location information, and mapping of regional attributes, and inputs them into AI models such as BERT with geographical information embedding or multilayer perceptron. Examples of input to the AI model include “Location: Shinjuku, Tokyo”, “Regional attribute: urban area, event: summer festival”. The AI model calculates regional suitability scores for each advertisement candidate (e.g., nearby store advertisement 0.95, region-specific campaign advertisement 0.90, local event advertisement 0.85) and optimal display methods (e.g., map banner, local event video, region-specific text). Examples of AI model output include “Ad ID:12345, display method: map banner, regional suitability: 0.95”, “Ad ID:67890, display method: event video, regional suitability: 0.90”. Based on these estimation results, the display unit automatically switches the advertisement display method and layout and renders advertisements optimized for the user interface. Subsequently, click events and display counts of the display results are sent to the advertisement effectiveness measurement unit and used for regional advertisement effectiveness analysis and continuous optimization of display methods. Unlike conventional advertisement display without consideration of geographical information or manual regional determination, the present display unit combines AI-based geographical information integration, regional attribute analysis, and automatic optimization of display parameters, resulting in significant improvements in regional adaptability, effectiveness, user experience, and operational efficiency of advertisement display. Applicable fields include messenger applications, SNS, tourism information services, regional event guide systems, e-commerce sites, and all interactive services requiring advertisement display that emphasizes geographical background.

The display unit can analyze the user's social media activity and propose display methods when displaying advertisements. For example, the display unit analyzes the user's social media activity and proposes display methods when displaying advertisements. Social media activity includes post content, number of likes, number of followers, and so on. For instance, the display unit can display related advertisements based on the user's history of likes and shares on social media. The display unit can also display related advertisements based on the accounts followed by the user on social media. Furthermore, the display unit can analyze the user's post content on social media and display related advertisements. By analyzing the user's social media activity, the display unit can provide the optimal display method. Some or all of the above-described processing in the display unit may be performed using AI or without AI. For example, the display unit can propose display methods by inputting the user's social media activity data into an AI model that proposes display methods. Specifically, the display unit receives input data such as the user's social media post content (text, image URL, post date and time), like and share history (post ID, action type, action date and time), and followed account list (account ID, category, follow date and time) as structured data. The display unit performs preprocessing on these data, such as tokenization, category classification, and time-series vectorization, and extracts features using large language models with Transformer architecture or graph neural networks. Examples of input to the AI model include “Post content: ‘Went to a new cafe’, ‘Uploaded travel photos’”, “Like history: cafe post, travel post”, “Followed accounts: gourmet, travel”. The AI model integrates these features to estimate the user's current interest topics and activity trends, and calculates relevance scores for each advertisement candidate (e.g., cafe advertisement 0.92, travel advertisement 0.88, gourmet advertisement 0.85) and optimal display methods (e.g., cafe advertisement as image banner, travel advertisement as video, gourmet advertisement as text). Examples of AI model output include “Ad ID:12345, display method: image banner, relevance: 0.92”, “Ad ID:67890, display method: video, relevance: 0.88”. Based on these estimation results, the display unit automatically switches the advertisement display method and layout and renders advertisements optimized for the user interface. Subsequently, click events and display counts of the display results are sent to the advertisement effectiveness measurement unit and used for correlation analysis between social media activity and advertisement effectiveness and continuous optimization of display methods. Unlike conventional static advertisement display or manual interest estimation, the present display unit combines AI-based social media activity analysis, graph structure analysis, and automatic optimization of display parameters, resulting in significant improvements in advertisement display personalization accuracy, real-time performance, advertisement effectiveness, and operational efficiency. Applicable fields include messenger applications, SNS, e-commerce sites, lifelog services, video streaming services, and all interactive services requiring social media-linked advertisement display.

The collection unit can estimate the user's emotion and adjust the timing of collecting behavioral history based on the estimated emotion of the user. For example, the collection unit estimates the user's emotion and adjusts the timing of collecting behavioral history according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the collection unit uses the emotion engine to prioritize the collection of positive behavioral history. When the user is feeling down, the collection unit can use the emotion engine to prioritize the collection of negative behavioral history. Furthermore, when the user is relaxed, the collection unit can use the emotion engine to prioritize the collection of neutral behavioral history. By adjusting the timing of collecting behavioral history according to the user's emotion, the collection unit enables more effective data collection. Some or all of the above-described processing in the collection unit may be performed using AI or without AI. For example, the collection unit can adjust the collection timing by inputting the user's emotion data into an AI model that adjusts the collection timing. Specifically, the collection unit receives multimodal input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The collection unit performs preprocessing on these input data, such as noise removal, speech-to-text conversion (speech recognition), and facial expression feature extraction from images (CNN-based image encoder). Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05). Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the collection unit dynamically adjusts behavioral history collection timing parameters (e.g., collection interval, collection start trigger, collection priority). For example, when positive emotion is strong, the collection frequency is increased at times when the user is taking proactive actions; when negative emotion is strong, collection is restrained to avoid stress factors and only necessary data are selectively collected. For neutral emotion, the normal collection schedule is maintained. The collection unit automates these controls based on threshold determination and time-series pattern analysis in high-dimensional feature space. Subsequently, the collected behavioral history is transferred to the advertisement selection unit or effectiveness measurement unit and used as input for advertisement personalization and effectiveness analysis. Unlike conventional uniform data collection or manual timing adjustment, the present collection unit combines AI-based multimodal emotion estimation and automatic optimization of collection timing, resulting in significant improvements in data collection efficiency, user experience, and collection accuracy. Applicable fields include messenger applications, SNS, healthcare chatbots, educational support systems, e-commerce sites, IoT device behavioral history collection, and all information services requiring user state-adaptive data collection.

The collection unit can analyze the user's past behavioral patterns and select the optimal collection method when collecting behavioral history. For example, the collection unit analyzes the user's past behavioral patterns and selects the optimal collection method when collecting behavioral history. Behavioral patterns include past behavioral history, frequency, trends, and so on. For instance, the collection unit can select the most effective collection timing based on the user's past behavioral patterns. The collection unit can also analyze the user's past behavioral patterns and collect behavioral history at specific times of day. Furthermore, the collection unit can customize the collection method by referring to the user's past behavioral patterns. By analyzing the user's past behavioral patterns, the collection unit can select the optimal collection method. Some or all of the above-described processing in the collection unit may be performed using AI or without AI. For example, the collection unit can select the collection method by inputting the user's past behavioral pattern data into an AI model that selects the collection method. Specifically, the collection unit receives input data such as the user's behavioral history for the past 30 days (e.g., time-series array of click events, app usage logs, search query history), behavioral frequency vectors (e.g., number of actions per day), and behavioral trend cluster IDs (e.g., night-type user, weekend-active type) as structured data. The collection unit performs preprocessing on these data, such as time-series vectorization, feature extraction, and clustering (e.g., K-means, autoencoder). Next, a behavioral pattern analysis AI model (e.g., LSTM-based time-series prediction model, gradient boosting decision tree, cluster classification model) estimates the optimal collection timing (e.g., weekday evenings, weekend mornings), collection frequency (e.g., every hour, once a day), and collection method (e.g., event-triggered, periodic batch) from these features. Examples of input to the AI model include “Behavioral history: click [2024, Jun. 1 12:00, 2024, Jun. 1 18:00]”, “Behavioral frequency: 5 times/day”, “Trend cluster: night-type”. Examples of output from the AI model include “Recommended collection timing: weekday 8 pm”, “Recommended collection method: event-triggered”. Based on these estimation results, the collection unit dynamically sets parameters for the collection scheduler or collection module (e.g., collection start time, collection interval, target events for collection). Subsequently, behavioral history collected by the optimized method is transferred to the advertisement selection unit or effectiveness measurement unit and contributes to improving the accuracy of advertisement personalization and effectiveness analysis. Unlike conventional uniform collection schedules or manual pattern analysis, the present collection unit combines AI-based time-series behavioral analysis, clustering, and automatic optimization of collection methods, resulting in significant improvements in data collection efficiency, accuracy, and operational burden. Applicable fields include messenger applications, SNS, e-commerce sites, IoT device usage history collection, and all information services requiring user behavioral pattern-adaptive data collection.

The collection unit can estimate the user's emotion and determine the priority of behavioral history to be collected based on the estimated emotion of the user. For example, the collection unit estimates the user's emotion and determines the priority of behavioral history to be collected according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the collection unit uses the emotion engine to prioritize the collection of positive behavioral history. When the user is feeling down, the collection unit can use the emotion engine to prioritize the collection of negative behavioral history. Furthermore, when the user is relaxed, the collection unit can use the emotion engine to prioritize the collection of neutral behavioral history. By determining the priority of behavioral history to be collected according to the user's emotion, the collection unit enables more effective data collection. Some or all of the above-described processing in the collection unit may be performed using AI or without AI. For example, the collection unit can determine the priority of behavioral history by inputting the user's emotion data into an AI model that determines the priority of behavioral history. Specifically, the collection unit receives multimodal input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The collection unit performs preprocessing on these input data, such as noise removal, speech-to-text conversion, and facial expression feature extraction from images. Next, an emotion estimation AI model (e.g., BERT-based emotion classification model, ResNet-based facial expression recognition model, RNN-based emotion estimation model using acoustic features) estimates emotion labels and emotion scores. Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the collection unit calculates priority scores for each type of behavioral history (e.g., positive behavior 0.90, negative behavior 0.80, neutral behavior 0.70) and collects behavioral history in order of highest priority. For example, when positive emotion is strong, purchase behavior and proactive action history are prioritized; when negative emotion is strong, problem reports and help browsing history are prioritized. For neutral emotion, all types of behavioral history are collected equally. The collection unit automates these controls by scoring and threshold determination in high-dimensional feature space. Subsequently, behavioral history collected according to priority is transferred to the advertisement selection unit or effectiveness measurement unit and contributes to improving the accuracy of advertisement personalization and effectiveness analysis. Unlike conventional uniform data collection or manual prioritization, the present collection unit combines AI-based multimodal emotion estimation and automatic optimization of behavioral history priority, resulting in significant improvements in data collection efficiency, accuracy, and user experience. Applicable fields include messenger applications, SNS, healthcare chatbots, educational support systems, e-commerce sites, IoT device behavioral history collection, and all information services requiring user state-adaptive data collection.

The collection unit can prioritize the collection of highly relevant behavioral history by considering the user's geographical location information when collecting behavioral history. For example, the collection unit prioritizes the collection of highly relevant behavioral history by considering the user's geographical location information when collecting behavioral history. Geographical location information includes GPS data, IP address, location information services, and so on. For instance, the collection unit can prioritize the collection of usage history for nearby stores or services based on the user's current location. The collection unit can also prioritize the collection of region-specific behavioral history based on the user's location information. Furthermore, the collection unit can prioritize the collection of local event or activity history by considering the user's location information. By considering the user's geographical location information, the collection unit can prioritize the collection of highly relevant behavioral history. Some or all of the above-described processing in the collection unit may be performed using AI or without AI. For example, the collection unit can collect behavioral history by inputting the user's geographical location information into an AI model that collects behavioral history. Specifically, the collection unit receives input data such as the user's current location information (GPS coordinates, IP address, region ID from location information services), regional attribute data (e.g., climate zone, regional event calendar, cultural characteristics), and past location history (e.g., list of visited regions in the past 30 days) as structured data. The collection unit performs preprocessing on these data, such as place name extraction, normalization of location information, and mapping of regional attributes, and inputs them into AI models such as BERT with geographical information embedding or multilayer perceptron. Examples of input to the AI model include “Location: Shinjuku, Tokyo”, “Regional attribute: urban area, event: summer festival”. The AI model calculates regional suitability scores for each behavioral history (e.g., nearby store usage history 0.95, region-specific event history 0.90, local activity history 0.85) and prioritizes the collection of behavioral history with high regional suitability. Examples of AI model output include “History ID:12345, regional suitability: 0.95”, “History ID:67890, regional suitability: 0.90”. Based on these estimation results, the collection unit dynamically adjusts the priority and frequency of behavioral history to be collected, enabling data collection optimized for the user's current location and regional characteristics. Subsequently, behavioral history with high regional suitability is transferred to the advertisement selection unit or effectiveness measurement unit and used for recommending region-specific advertisements or local event information. Unlike conventional data collection without consideration of geographical information or manual regional determination, the present collection unit combines AI-based geographical information integration, regional attribute analysis, and automatic optimization of collection parameters, resulting in significant improvements in regional adaptability, accuracy, and operational efficiency of data collection. Applicable fields include messenger applications, SNS, tourism information services, regional event guide systems, IoT device usage history collection, and all interactive services requiring data collection that emphasizes geographical background.

The measurement unit can estimate the user's emotion and adjust the method of measuring advertisement effectiveness based on the estimated emotion of the user. For example, the measurement unit estimates the user's emotion and adjusts the method of measuring advertisement effectiveness according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the measurement unit uses the emotion engine to emphasize the measurement of positive reactions. When the user is feeling down, the measurement unit can use the emotion engine to measure negative reactions more discreetly. Furthermore, when the user is relaxed, the measurement unit can use the emotion engine to measure neutral reactions in a balanced manner. By adjusting the method of measuring advertisement effectiveness according to the user's emotion, the measurement unit enables more accurate measurement. Some or all of the above-described processing in the measurement unit may be performed using AI or without AI. For example, the measurement unit can adjust the measurement method by inputting the user's emotion data into an AI model that adjusts the measurement method. Specifically, the measurement unit receives multimodal input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The measurement unit performs preprocessing on these input data, such as noise removal, speech-to-text conversion, and facial expression feature extraction from images. Next, an emotion estimation AI model (e.g., BERT-based emotion classification model, ResNet-based facial expression recognition model, RNN-based emotion estimation model using acoustic features) estimates emotion labels and emotion scores. Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the measurement unit dynamically adjusts advertisement effectiveness measurement parameters (e.g., weighting of click-through rate, conversion rate, engagement rate, threshold for reaction classification). For example, when positive emotion is strong, affirmative reactions (e.g., clicks, shares, comments) are emphasized in measurement; when negative emotion is strong, negative reactions (e.g., ad hidden, skipped) are aggregated more discreetly. For neutral emotion, all reactions are evaluated equally. The measurement unit automates these controls by scoring and threshold determination in high-dimensional feature space. Subsequently, the adjusted advertisement effectiveness measurement results are fed back to advertisers and the advertisement selection unit and used for automatic optimization of advertisement creatives and delivery strategies. Unlike conventional uniform effectiveness measurement or manual emotion judgment, the present measurement unit combines AI-based multimodal emotion estimation and automatic optimization of measurement parameters, resulting in significant improvements in measurement accuracy, user adaptability, and operational efficiency of advertisement effectiveness measurement. Applicable fields include online advertising platforms, SNS advertising, video advertising, in-app advertising, and all digital advertising delivery infrastructures requiring user state-adaptive advertisement effectiveness measurement.

The measurement unit can optimize the measurement algorithm by referring to past measurement data when measuring advertisement effectiveness. For example, the measurement unit optimizes the measurement algorithm by referring to past measurement data when measuring advertisement effectiveness. Measurement data includes past measurement results, statistical data, analysis reports, and so on. For instance, the measurement unit can select the most effective measurement method based on past advertisement effectiveness data. The measurement unit can also analyze past measurement data to optimize the measurement algorithm. Furthermore, the measurement unit can customize the measurement method by referring to past measurement data. By referring to past measurement data, the measurement unit can optimize the measurement algorithm. Some or all of the above-described processing in the measurement unit may be performed using AI or without AI. For example, the measurement unit can optimize the measurement algorithm by inputting past measurement data into an AI model that optimizes the measurement algorithm. Specifically, the measurement unit receives input data such as past advertisement display events (advertisement ID, display date and time, display position, device information), click events (click date and time, user ID, advertisement ID), conversion events (purchase completion, membership registration, app installation, etc.), time-series data, past measurement results (e.g., CTR, CVR, engagement rate), statistical data (e.g., mean, variance, standard deviation), and analysis reports (e.g., A/B test results, effectiveness trend graphs) as structured data. The measurement unit performs preprocessing on these data, such as time-series vectorization, feature extraction, and outlier removal. Next, a measurement algorithm optimization AI model (e.g., gradient boosting decision tree, random forest, LSTM-based time-series prediction model) estimates the optimal measurement method (e.g., CTR-focused, CVR-focused, engagement-focused), measurement parameters (e.g., aggregation period, weighting of evaluation indices), and algorithm selection (e.g., moving average, regression analysis, clustering). Examples of input to the AI model include “Ad ID:12345, past CTR: [0.10, 0.12, 0.11], CVR: [0.02, 0.03, 0.025]”, “A/B test results: variant A 0.15, variant B 0.18”. Examples of output from the AI model include “Recommended measurement method: CTR-focused, aggregation period: 7 days”, “Recommended algorithm: LSTM time-series prediction”. Based on these estimation results, the measurement unit dynamically sets parameters and algorithms for the measurement module to optimize the accuracy and real-time performance of advertisement effectiveness measurement. Subsequently, the optimized measurement results are fed back to advertisers and the advertisement selection unit and used for automatic optimization of advertisement creatives and delivery strategies. Unlike conventional static measurement methods or manual algorithm selection, the present measurement unit combines AI-based time-series effectiveness prediction, automatic optimization of measurement algorithms, and parameter tuning, resulting in significant improvements in measurement accuracy, operational efficiency, and automation of advertisement effectiveness measurement. Applicable fields include online advertising platforms, SNS advertising, video advertising, in-app advertising, and all digital advertising delivery infrastructures requiring advertisement optimization based on effectiveness data.

The measurement unit can estimate the user's emotion and adjust the method of displaying measurement results based on the estimated emotion of the user. For example, the measurement unit estimates the user's emotion and adjusts the method of displaying measurement results according to the estimated emotion. Emotion estimation is realized, for example, by using an emotion estimation function implemented with an emotion engine or generative AI. Generative AI may include text generation AI (e.g., LLM) or multimodal generative AI, but is not limited to these examples. For instance, when the user is excited, the measurement unit uses the emotion engine to emphasize the display of positive measurement results. When the user is feeling down, the measurement unit can use the emotion engine to display negative measurement results more discreetly. Furthermore, when the user is relaxed, the measurement unit can use the emotion engine to display neutral measurement results in a balanced manner. By adjusting the method of displaying measurement results according to the user's emotion, the measurement unit enables more effective display. Some or all of the above-described processing in the measurement unit may be performed using AI or without AI. For example, the measurement unit can adjust the display method by inputting the user's emotion data into an AI model that adjusts the display method. Specifically, the measurement unit receives multimodal input data such as chat content (UTF-8 encoded string array, e.g., “I'm very happy today”, “I've been feeling down lately”), audio data (WAV format sampled at 16 kHz, e.g., 5 seconds of spoken audio), and image data (JPEG/PNG format, e.g., selfies or sticker images). The measurement unit performs preprocessing on these input data, such as noise removal, speech-to-text conversion, and facial expression feature extraction from images. Next, an emotion estimation AI model (e.g., BERT-based emotion classification model, ResNet-based facial expression recognition model, RNN-based emotion estimation model using acoustic features) estimates emotion labels and emotion scores. Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotion information, the measurement unit dynamically adjusts measurement result display parameters (e.g., highlight color, font size, display order, display frequency). For example, when positive emotion is strong, affirmative measurement results are displayed with prominent colors and large fonts; when negative emotion is strong, negative measurement results are displayed with subdued colors and small fonts. For neutral emotion, all measurement results are displayed in a balanced manner. Examples of AI model output include “Measurement result ID:12345, display method: highlight color #FFCC00, font size: 24 px”, “Measurement result ID:67890, display method: grayscale, font size: 14 px”. Subsequently, the adjusted measurement result display is rendered on the user interface, contributing to optimization of user experience and stress reduction. Unlike conventional uniform display or manual emotion judgment, the present measurement unit combines AI-based multimodal emotion estimation and automatic optimization of display parameters, resulting in significant improvements in display adaptability, user satisfaction, and processing efficiency. Applicable fields include online advertising platforms, SNS advertising, healthcare chatbots, educational support systems, and all interactive services requiring information display adapted to the user's emotional state.

The measurement unit can consider the user's geographical location information when measuring advertisement effectiveness. For example, the measurement unit considers the user's geographical location information when measuring advertisement effectiveness. Geographical location information includes GPS data, IP address, location information services, and so on. For instance, the measurement unit can measure the effectiveness of advertisements for nearby stores or services based on the user's current location. The measurement unit can also measure the effectiveness of region-specific advertisements based on the user's location information. Furthermore, the measurement unit can measure the effectiveness of advertisements for local events or activities by considering the user's location information. By considering the user's geographical location information, the measurement unit enables more accurate measurement of advertisement effectiveness. Some or all of the above-described processing in the measurement unit may be performed using AI or without AI. For example, the measurement unit can measure advertisement effectiveness by inputting the user's geographical location information into an AI model that measures advertisement effectiveness. Specifically, the measurement unit receives input data such as the user's current location information (GPS coordinates, IP address, region ID from location information services), regional attribute data (e.g., climate zone, regional event calendar, cultural characteristics), past location history (e.g., list of visited regions in the past 30 days), advertisement display events (advertisement ID, display date and time, display position), click events, conversion events, and other structured data. The measurement unit performs preprocessing on these data, such as place name extraction, normalization of location information, mapping of regional attributes, and time-series vectorization. Next, AI models such as BERT with geographical information embedding or multilayer perceptron calculate advertisement effectiveness indicators for each region (e.g., CTR, CVR, engagement rate) and output regional suitability scores and region-specific effectiveness scores. Examples of input to the AI model include “Location: Shinjuku, Tokyo”, “Regional attribute: urban area, event: summer festival”, “Ad ID:12345, display history: [2024 Jun. 1 12:00]”. Examples of output from the AI model include “Ad ID:12345, regional suitability: 0.95, CTR: 0.13”, “Ad ID:67890, regional suitability: 0.90, CVR: 0.025”. Based on these estimation results, the measurement unit enables regional advertisement effectiveness analysis and optimization of delivery strategies. Subsequently, advertisement effectiveness measurement results with high regional suitability are fed back to advertisers and the advertisement selection unit and used for recommending region-specific advertisements or local event information. Unlike conventional effectiveness measurement without consideration of geographical information or manual regional determination, the present measurement unit combines AI-based geographical information integration, regional attribute analysis, and automatic optimization of measurement parameters, resulting in significant improvements in regional adaptability, accuracy, and operational efficiency of advertisement effectiveness measurement. Applicable fields include online advertising platforms, SNS advertising, tourism information services, regional event guide systems, and all interactive services requiring advertisement effectiveness measurement that emphasizes geographical background.

The system according to the embodiment is not limited to the above-described examples and can be variously modified as follows, for example. Specifically, the present system allows for diverse variations in AI model architecture, data flow, input/output specifications, parameter settings, learning methods, hardware configuration, and so on. For example, AI models may be appropriately combined from Transformer architecture, CNN, RNN, gradient boosting decision tree, random forest, graph neural network, and others. Regarding data flow, not only sequential processing by a single module but also cooperation among multiple AI models, pipeline processing, parallel processing on distributed clusters, and cooperative processing between edge devices and the cloud can be flexibly designed according to system requirements and use cases. Input/output specifications can support various data types and formats, including text, audio, image, video, sensor data, and streaming data from IoT devices. Parameter settings and learning methods can be optimally selected according to objectives and operational environments, including supervised learning, unsupervised learning, reinforcement learning, transfer learning, online learning, and feedback learning via A/B testing. Hardware configurations may include parallel computing clusters using GPUs, inference acceleration with FPGA or ASIC, lightweight model implementation on edge devices, and various implementation forms according to processing performance, power consumption, and cost requirements. By allowing these variations, the present system exhibits a technical effect of flexibly adapting to technological evolution and changes in operational requirements, unlike conventional fixed AI systems or information processing dependent on a single algorithm. Applicable fields include messenger applications, SNS, e-commerce sites, video streaming services, IoT device-linked services, healthcare chatbots, educational support systems, and all interactive information services and data analysis platforms.

The analysis unit can analyze the tone of voice of conversation participants when analyzing chat content to estimate emotion. For example, the analysis unit can estimate positive emotion when the user's voice tone is elevated, and estimate negative emotion when the tone is low. The analysis unit can also analyze the length and frequency of silences in the conversation to estimate the user's emotional state. Furthermore, the analysis unit can detect audio features such as laughter or sighs in the conversation to improve the accuracy of emotion estimation. By considering voice tone and audio features, the analysis unit enables more accurate emotion estimation. Specifically, the analysis unit receives input data such as chat content and audio data (e.g., WAV format sampled at 16 kHz, 5-30 seconds of speech clips). The analysis unit performs preprocessing on the audio signal, such as noise removal, volume normalization, and frame segmentation (e.g., 25 ms window, 10 ms shift), and extracts acoustic features (e.g., fundamental frequency F0, formants, Mel-frequency cepstral coefficients MFCC, zero-crossing rate, energy, spectral slope). These features are input as time-series tensors (e.g., number of frames×number of feature dimensions, 500×40) into an audio emotion recognition AI model (e.g., RNN-based acoustic classification model, CNN-LSTM hybrid model, Transformer-based audio encoder). Examples of input to the AI model include “Audio: speech with an elevated tone (F0 average 250 Hz, high energy, MFCC features)” and “Audio: speech with many silent intervals (silent interval rate 0.35)”. The AI model outputs emotion labels (e.g., positive, negative, neutral), emotion scores (e.g., joy 0.80, sadness 0.10, anger 0.05, surprise 0.05), statistics on silent intervals, and detection results for nonverbal audio events such as laughter and sighs. Examples of AI model output include “Emotion label: positive, score: 0.85, silence rate: 0.05, laughter detected: yes” and “Emotion label: negative, score: 0.70, sigh detected: yes”. Based on these output results, the analysis unit dynamically adjusts emotion estimation parameters (e.g., thresholds, weights, integration parameters with past history) and generates the final emotion estimation result. Subsequently, the estimated emotion information is transferred to the advertisement selection unit and display unit and used for advertisement recommendation and display control according to the user's state. Unlike conventional text-only emotion estimation or manual audio evaluation, the present analysis unit combines high-dimensional time-series analysis of acoustic features, nonverbal audio event detection, and automatic parameter optimization by AI, resulting in significant improvements in emotion estimation accuracy, real-time performance, and diversity. Applicable fields include messenger applications, call center automated response, healthcare chatbots, educational support systems, and meeting recording services with emotion analysis, and all interactive services requiring voice emotion estimation.

The selection unit can analyze the user's purchase history and prioritize the selection of advertisements for specific brands or products. For example, the selection unit can advertise new products or related products of the same brand based on products the user has previously purchased. The selection unit can also prioritize advertisements for product categories frequently purchased by the user. Furthermore, the selection unit can analyze the user's purchase history and select product advertisements tailored to seasons or events. By considering the user's purchase history, the selection unit can provide more relevant advertisements. Specifically, the selection unit receives input data such as the user's purchase history (e.g., product ID, brand ID, category ID, purchase date and time, purchase amount, purchase channel). The selection unit performs preprocessing on these data, such as one-hot encoding of categorical variables, time-series vectorization, and tagging for season or event (e.g., summer, Christmas, sale period). The selection unit inputs feature vectors (e.g., number of purchases by brand over the past 90 days, purchase frequency by category, purchase trend by event) into an advertisement selection AI model (e.g., gradient boosting decision tree, random forest, Transformer-based purchase history encoder). Examples of input to the AI model include “Brand ID: ABC, past purchase count: 5, category: electronics, event: summer sale” and “Brand ID: XYZ, past purchase count: 2, category: food, event: Christmas”. The AI model calculates relevance scores for each advertisement candidate (e.g., new product advertisement for brand 0.95, category-related advertisement 0.90, event-linked advertisement 0.88) and priority labels (e.g., high, medium, low). Examples of AI model output include “Ad ID:12345, relevance: 0.95, priority: high” and “Ad ID:67890, relevance: 0.88, priority: medium”. Based on these scores, the selection unit transfers the optimal advertisement list to the display unit. Subsequently, advertisement display results and click events are sent to the advertisement effectiveness measurement unit and used for continuous optimization of the advertisement selection algorithm through online learning and A/B testing. Unlike conventional static rule-based advertisement selection or manual purchase history analysis, the present selection unit combines AI-based time-series purchase history analysis, event-linked advertisement selection, and automatic parameter optimization, resulting in significant improvements in advertisement personalization accuracy, advertisement effectiveness, and operational efficiency. Applicable fields include e-commerce sites, messenger applications, point card applications, retail-linked services, and all interactive services requiring purchase history-linked advertisement recommendation.

The display unit can adjust the method of displaying advertisements by considering the battery level of the user's device. For example, when the battery level is low, the display unit can prioritize lightweight text advertisements. When the battery level is sufficient, the display unit can display video advertisements or interactive advertisements. Furthermore, the display unit can adjust the frequency of advertisement display according to the battery level. By considering the battery status of the user's device, the display unit enables advertisement display without compromising user experience. Specifically, the display unit receives input data such as device information (e.g., battery level percentage, charging status, device type, OS version). The display unit performs preprocessing such as normalization of battery level (e.g., 0-1 scale), threshold determination (e.g., less than 20%, 20-50%, 50% or more), and extraction of display constraints by device type. The display unit inputs these features into a device optimization AI model (e.g., multilayer perceptron, decision tree, rule-based optimization module) and calculates display method scores for each advertisement (e.g., text advertisement 0.95, image advertisement 0.80, video advertisement 0.60), display frequency scores (e.g., number of displays per minute), and display format labels (e.g., lightweight, standard, rich). Examples of input to the AI model include “Battery level: 15%, device: smartphone” and “Battery level: 80%, device: tablet”. Examples of output from the AI model include “Recommended display method: text, score: 0.95, display frequency: 2 times/min” and “Recommended display method: video, score: 0.85, display frequency: 5 times/min”. Based on these estimation results, the display unit automatically switches the advertisement layout, display format, and display frequency and renders advertisements optimized for the user interface. Subsequently, click events and display counts of the display results are sent to the advertisement effectiveness measurement unit and used for battery-level-specific advertisement effectiveness analysis and continuous optimization of display methods. Unlike conventional uniform advertisement display or manual battery determination, the present display unit combines AI-based device information analysis, battery status adaptation, and automatic optimization of display parameters, resulting in significant improvements in advertisement display adaptability, user experience, advertisement effectiveness, and operational efficiency. Applicable fields include messenger applications, SNS, e-commerce sites, video streaming services, IoT device interfaces, and all interactive services requiring battery status-adaptive advertisement display.

The analysis unit can analyze the gestures and facial expressions of conversation participants when analyzing chat content to estimate emotion. For example, the analysis unit can analyze the user's facial expressions in real time via camera and detect changes such as smiles or frowning. The analysis unit can also analyze the user's gestures (e.g., waving hands, scratching head) to estimate emotional state. Furthermore, the analysis unit can track the user's gaze movement to estimate the degree of interest or attention. By considering gestures and facial expressions, the analysis unit enables more accurate emotion estimation. Specifically, the analysis unit receives input data such as camera video data (e.g., RGB image frame sequence at 30 fps, resolution 640×480 or higher). The analysis unit performs preprocessing such as face detection (e.g., MTCNN, Haar Cascade), facial landmark extraction (e.g., 68-point features), facial expression feature extraction (e.g., mouth corner elevation, brow contraction, eye opening/closing), gesture recognition (e.g., hand position/movement vectors, skeleton estimation), and gaze estimation (e.g., pupil position vectors, gaze point coordinates). These features are input as time-series tensors (e.g., number of frames×number of feature dimensions, 900×128) into facial expression/gesture recognition AI models (e.g., ResNet-based facial expression classification model, 3D-CNN-based gesture recognition model, regression model for gaze estimation). Examples of input to the AI model include “Image: smiling expression frame sequence”, “Image: waving hand motion frame sequence”, “Image: gaze concentrated at center of screen”. The AI model outputs emotion labels (e.g., joy, sadness, surprise, anger, neutral), emotion scores (e.g., joy 0.80, surprise 0.10), gesture labels (e.g., waving hand 0.95), and gaze concentration scores (e.g., interest level 0.90). Examples of AI model output include “Emotion label: joy, score: 0.85, gesture: waving hand 0.95” and “Emotion label: surprise, score: 0.70, gaze concentration: 0.90”. Based on these output results, the analysis unit dynamically adjusts emotion estimation parameters and interest estimation parameters and generates the final emotion/interest estimation result. Subsequently, the estimated emotion/interest information is transferred to the advertisement selection unit and display unit and used for advertisement recommendation and display control according to the user's state. Unlike conventional text/audio-only emotion estimation or manual evaluation of facial expressions/gestures, the present analysis unit combines high-dimensional feature extraction from image/video data, time-series analysis, and automatic parameter optimization by AI, resulting in significant improvements in emotion/interest estimation accuracy, real-time performance, and diversity. Applicable fields include messenger applications, video conferencing systems, healthcare chatbots, educational support systems, interview evaluation services with emotion analysis, and all interactive services requiring facial expression/gesture analysis.

The collection unit can collect the user's health data and utilize it for advertisement selection. For example, the collection unit can collect data such as heart rate and step count from the user's fitness tracker or smartwatch. The collection unit can also collect the user's sleep data and select health-related advertisements according to sleep quality. Furthermore, the collection unit can collect the user's meal records and select advertisements for nutritional supplements or health foods. By considering the user's health data, the collection unit can provide more personalized advertisements. Specifically, the collection unit receives input data such as health data (e.g., heart rate time-series data, daily step count aggregation, sleep score, meal record text, calorie intake, activity level, weight/body fat percentage, blood pressure, blood glucose, etc.). The collection unit performs preprocessing such as data normalization (e.g., heart rate 60-180 bpm, step count 0-20,000), time-series vectorization, category classification (e.g., meal type, exercise type), and outlier removal. The collection unit inputs these features into a health status analysis AI model (e.g., LSTM-based time-series health prediction model, gradient boosting decision tree, Transformer-based multimodal health data integration model) and calculates health status labels (e.g., good, caution, needs improvement), health scores (e.g., 0.85), and advertisement category suitability scores (e.g., supplement advertisement 0.90, exercise equipment advertisement 0.80, sleep improvement advertisement 0.75). Examples of input to the AI model include “Heart rate: average 75 bpm, step count: 8,000 steps/day, sleep score: 85” and “Meal record: breakfast: bread, lunch: salad, dinner: fish”. Examples of output from the AI model include “Health status: good, advertisement category: supplement, suitability: 0.90” and “Health status: needs improvement, advertisement category: sleep improvement, suitability: 0.80”. Based on these estimation results, the collection unit transfers the results to the advertisement selection unit and realizes advertisement recommendation optimized for health status and lifestyle. Subsequently, advertisement display results and click events are sent to the advertisement effectiveness measurement unit and used for health data-linked advertisement effectiveness analysis and continuous optimization of advertisement selection algorithms. Unlike conventional static attribute-based advertisement selection or manual health data analysis, the present collection unit combines AI-based multimodal health data integration, time-series analysis, and automatic optimization of advertisement suitability, resulting in significant improvements in advertisement personalization accuracy, advertisement effectiveness, and user experience. Applicable fields include healthcare applications, fitness services, wearable device-linked services, health food e-commerce sites, and all interactive services requiring health data-linked advertisement recommendation.

The analysis unit can perform analysis by taking into account the past emotional history of the participants in the conversation when analyzing chat content. For example, the analysis unit can record what kind of emotions the user exhibited in past conversations and utilize this information in the analysis of the current conversation. Furthermore, the analysis unit can predict the user's emotional response to specific topics based on past emotional history. Additionally, the analysis unit can analyze patterns of emotional change by referring to past emotional history and estimate the current emotional state more accurately. By considering past emotional history, the analysis unit can improve the accuracy of emotion estimation. Specifically, the analysis unit receives, as input data, an emotion history database for each user (e.g., conversation ID, timestamp, emotion label, emotion score, topic ID, conversation context). The analysis unit performs preprocessing such as time-series vectorization (e.g., time-series of emotion scores over the past 30 days), aggregation of emotional responses by topic, and extraction of emotional change patterns (e.g., moving average, trend scoring). The analysis unit inputs these features into an emotion history analysis AI model (e.g., LSTM-based time-series prediction model, Transformer-based history encoder, clustering model) and calculates the current emotional state estimate (e.g., positive 0.80, negative 0.10), predicted emotional response by topic (e.g., topic A: joy 0.85, topic B: sadness 0.70), and emotional change trends (e.g., upward trend, downward trend, stable). Examples of input to the AI model include “Past emotional history: positive 0.70→0.80→0.85”, “Topic: travel, past response: joy 0.90, surprise 0.10”. Examples of output from the AI model include “Current emotion: positive, score: 0.88”, “Topic A response prediction: joy 0.85”, “Emotion trend: upward”. Based on these estimation results, the analysis unit dynamically adjusts emotion estimation parameters and topic analysis parameters to generate the final emotion estimation and topic response prediction. In subsequent processing, the estimated emotional information is transferred to the advertisement selection unit and display unit, and is used for advertisement recommendation and display control according to the user's state. Unlike conventional one-off emotion estimation or manual history analysis, the present analysis unit combines AI-based time-series emotion history analysis, topic-linked response prediction, and automatic parameter optimization, resulting in significant improvements in the accuracy, personalization, and real-time performance of emotion estimation. Application fields include messenger applications, healthcare chatbots, educational support systems, customer support with emotion analysis, and other interactive services requiring emotion history-linked analysis.

The selection unit can analyze the interests of a user's followers on social media and utilize this information for advertisement selection. For example, the selection unit can analyze the content that the user's followers frequently “like” or share and select related advertisements. Additionally, the selection unit can estimate interests based on the accounts followed by the user's followers and select advertisements accordingly. Furthermore, the selection unit can analyze the posts of the user's followers and select advertisements that match current trends and topics. By considering the interests of the user's followers on social media, the selection unit can provide more effective advertisements. Specifically, the selection unit receives, as input data, follower activity data (e.g., post content text, image URLs, post timestamps, like history, share history, followed account list, action type, action timestamp). The selection unit performs preprocessing such as tokenization, category classification, time-series vectorization, trend word extraction (e.g., TF-IDF, BERT embedding), and clustering (e.g., interest clusters, topic clusters). The selection unit inputs these features into a follower interest analysis AI model (e.g., Transformer-based large language model, graph neural network, cluster classification model) and calculates relevance scores for each advertisement candidate (e.g., trend advertisement 0.92, topic advertisement 0.88, category advertisement 0.85) and interest cluster labels (e.g., gourmet, travel, fashion). Examples of input to the AI model include “Follower post: cafe, travel”, “Like history: gourmet post, travel post”, “Followed accounts: gourmet, travel”. Examples of output from the AI model include “Advertisement ID:12345, relevance: 0.92, cluster: gourmet”, “Advertisement ID:67890, relevance: 0.88, cluster: travel”. Based on these estimation results, the selection unit transfers the optimal advertisement list to the advertisement display unit. In subsequent processing, advertisement display results and click events are sent to the advertisement effectiveness measurement unit and used for follower interest-linked advertisement effectiveness analysis and continuous optimization of the advertisement selection algorithm. Unlike conventional static attribute-based advertisement selection or manual follower analysis, the present selection unit combines AI-based social graph analysis, trend extraction, and automatic parameter optimization, resulting in significant improvements in advertisement personalization accuracy, effectiveness, and real-time performance. Application fields include SNS, messenger applications, influencer collaboration services, EC sites, and other interactive services requiring follower interest-linked advertisement recommendation.

The display unit can estimate the user's emotion and adjust the timing of advertisement display based on the estimated emotion. For example, when the user is excited, the display unit can immediately display positive advertisements using an emotion engine. When the user is feeling down, the display unit can display encouraging advertisements at an appropriate timing using the emotion engine. Furthermore, when the user is relaxed, the display unit can display neutral advertisements at a natural timing using the emotion engine. By adjusting the timing of advertisement display according to the user's emotion, the display unit can provide more effective advertisement display. Specifically, the display unit receives, as input data, multimodal data such as chat content (UTF-8 encoded string array, e.g., “I'm very happy today”, “I've been feeling down lately”), audio data (16 kHz sampled WAV format, e.g., 5 seconds of spoken audio), and image data (JPEG/PNG format, e.g., selfies or sticker images). The display unit performs preprocessing such as noise removal, speech-to-text conversion, and facial expression feature extraction from images. Next, an emotion estimation AI model (e.g., BERT-based emotion classification model, ResNet-based facial expression recognition model, RNN-based emotion estimation model using acoustic features) estimates emotion labels (e.g., positive, negative, neutral) and emotion scores (e.g., joy 0.80, sadness 0.10, anger 0.05, surprise 0.05). Examples of input to the AI model include “Text: I'm very happy today”, “Audio: speech with an excited tone”, “Image: smiling expression”. Examples of output from the AI model include “Emotion label: positive, score: 0.85”, “Emotion label: negative, score: 0.70”. Based on the estimated emotional information, the display unit dynamically adjusts advertisement display timing parameters for each advertisement (e.g., immediate display, delayed display, natural timing display, display interval). For example, when positive emotion is strong, affirmative advertisements are displayed immediately; when negative emotion is strong, encouraging advertisements are displayed at a timing when the user's stress is reduced; and for neutral emotion, all types of advertisements are displayed evenly at natural timing. Examples of output from the AI model include “Advertisement ID:12345, display timing: immediate”, “Advertisement ID:67890, display timing: delayed by 2 seconds”. In subsequent processing, the adjusted advertisement display is rendered on the user interface, and click events and display counts are sent to the advertisement effectiveness measurement unit. Unlike conventional uniform display timing or manual emotion judgment, the present display unit combines AI-based multimodal emotion estimation and automatic optimization of display timing, resulting in significant improvements in advertisement display effectiveness, user experience, advertisement effectiveness, and operational efficiency. Application fields include messenger applications, SNS, healthcare chatbots, educational support systems, EC sites, video streaming services, and other interactive services requiring advertisement display timing control according to the user's emotional state.

The collection unit can collect usage status of the user's device and utilize this information for advertisement selection. For example, the collection unit can record which applications the user frequently uses and select related advertisements. Additionally, the collection unit can analyze the time periods during which the user uses the device and select the optimal advertisement display timing. Furthermore, the collection unit can adjust the advertisement selection method by considering the user's device settings (e.g., notification settings, privacy settings). By considering the usage status of the user's device, the collection unit can provide more personalized advertisements. Specifically, the collection unit receives, as input data, device usage logs (e.g., application ID, launch count, usage time, usage date and time, background operation status), device setting information (e.g., notification ON/OFF, privacy level, location permission), and usage time histograms (e.g., usage count per hour) as structured data. The collection unit performs preprocessing such as one-hot encoding of categorical variables, time-series vectorization, and feature extraction (e.g., most frequently used application, peak usage time, setting cluster). The collection unit inputs these features into a device usage analysis AI model (e.g., gradient boosting decision tree, LSTM-based time-series prediction model, cluster classification model) and calculates advertisement category suitability scores (e.g., game advertisement 0.90, news advertisement 0.85, shopping advertisement 0.80), recommended display timing (e.g., weekday evenings, weekend mornings), and advertisement selection parameters (e.g., push advertisement when notifications are allowed, non-personalized advertisement when privacy is high). Examples of input to the AI model include “Application usage: game 10 times/day, news 5 times/day”, “Usage time: peak at night”, “Notification setting: ON”. Examples of output from the AI model include “Advertisement category: game, suitability: 0.90, display timing: night”, “Advertisement category: news, suitability: 0.85, display timing: morning”. The collection unit transfers these estimation results to the advertisement selection unit to realize advertisement recommendation optimized for device usage status. In subsequent processing, advertisement display results and click events are sent to the advertisement effectiveness measurement unit and used for device usage-linked advertisement effectiveness analysis and continuous optimization of the advertisement selection algorithm. Unlike conventional static attribute-based advertisement selection or manual usage status analysis, the present collection unit combines AI-based device usage log analysis, time-series pattern extraction, and automatic optimization of advertisement suitability, resulting in significant improvements in advertisement personalization accuracy, effectiveness, and user experience. Application fields include messenger applications, SNS, EC sites, IoT device collaboration services, and other interactive services requiring device usage-linked advertisement recommendation.

The analysis unit can perform analysis by taking into account the cultural background of the participants in the conversation when analyzing chat content. For example, the analysis unit can extract culturally appropriate keywords by considering the nationality and language of the participants in the conversation. Additionally, the analysis unit can identify cultural events and customs mentioned in the conversation and analyze related topics. Furthermore, the analysis unit can accurately understand the meaning of specific expressions and phrases based on the cultural background of the participants in the conversation. By considering cultural background, the analysis unit can achieve more accurate analysis of chat content. Specifically, the analysis unit receives, as input data, chat content (UTF-8 encoded string array), participant profiles (e.g., nationality, native language, country of residence, cultural area ID), conversation history (e.g., past utterances, topic history), and cultural event databases (e.g., holidays, festivals, traditional event lists). The analysis unit performs preprocessing such as language identification, cultural area mapping, keyword extraction (e.g., cultural event names, idioms), and expression pattern analysis (e.g., metaphors, euphemisms, honorifics). The analysis unit inputs these features into a culturally adaptive natural language processing AI model (e.g., multilingual BERT, Transformer with cultural knowledge embedding, rule-based expression interpretation module) and calculates cultural suitability scores (e.g., 0.95), extracted keyword lists (e.g., Easter, Spring Festival, Thanksgiving), and expression interpretation labels (e.g., literal translation, free translation, culture-dependent). Examples of input to the AI model include “Language: English, nationality: USA, utterance: Happy Thanksgiving!”, “Language: Chinese, nationality: China, utterance: [symbol] ”. Examples of output from the AI model include “Keyword: Thanksgiving, cultural suitability: 0.95”, “Keyword: Spring Festival, cultural suitability: 0.98”. Based on these estimation results, the analysis unit dynamically adjusts chat content analysis parameters and topic classification parameters to generate the final analysis results. In subsequent processing, the analysis results are transferred to the advertisement selection unit and display unit and used for advertisement recommendation and information presentation optimized for cultural background. Unlike conventional analysis based on a single language or culture or manual cultural judgment, the present analysis unit combines AI-based multilingual and multicultural data integration, cultural knowledge embedding, and automatic optimization of expression interpretation, resulting in significant improvements in the accuracy, adaptability, and diversity of chat content analysis. Application fields include global messenger applications, multilingual chatbots, international educational support systems, cultural event guide services, and other interactive services requiring cultural background-adaptive information analysis.

Below, the processing flow of Example of the Embodiment is briefly described. Specifically, the present system comprises multiple AI modules that integratively process diverse data such as chat content, user attributes, behavioral history, emotional state, device information, geographic location information, health data, and social media activity. Each module performs preprocessing such as data normalization, feature extraction, category classification, time-series vectorization, noise removal, and multimodal conversion of image/audio/text. In the analysis unit, high-dimensional features are extracted and integrated from input data using natural language processing AI models (e.g., BERT, Transformer), speech emotion recognition models (e.g., RNN, CNN-LSTM), facial and gesture recognition models (e.g., ResNet, 3D-CNN), health data analysis models (e.g., LSTM, gradient boosting decision tree), and culturally adaptive NLP models (e.g., multilingual BERT). The selection unit calculates relevance scores and suitability scores for each advertisement candidate based on the output of the analysis unit (e.g., keywords, emotion labels, health status, cultural suitability, purchase history vector, follower interest cluster), and generates an optimal advertisement list using an advertisement selection AI model (e.g., gradient boosting decision tree, random forest, Transformer). The display unit automatically adjusts advertisement layout, display format, display timing, and display frequency based on the output of the selection unit (e.g., advertisement ID, display method score, display timing, display frequency, device optimization parameters) so as not to impair the user experience, and renders the advertisements on the user interface. The collection unit collects user behavioral history, health data, and device usage logs in real time to build a data infrastructure for advertisement personalization and effectiveness measurement. The measurement unit analyzes effectiveness indicators such as advertisement display, clicks, and conversions using AI models and automatically optimizes advertisement effectiveness measurement parameters and algorithms. These processes can be implemented on various hardware configurations, including parallel computing clusters using GPUs, lightweight models on edge devices, and distributed processing via cloud collaboration, and can be combined with continuous optimization through online learning and A/B testing, resulting in significant improvements in the accuracy, real-time performance, and operational efficiency of advertisement recommendation, display, and effectiveness measurement. Application fields include messenger applications, SNS, EC sites, video streaming services, IoT device collaboration services, healthcare chatbots, educational support systems, and can be deployed to any interactive information service or data analysis infrastructure.

Step 1: The analysis unit analyzes the chat content of the messenger application. The chat content includes text messages, voice messages, and images. The analysis unit analyzes the chat content using natural language processing technology. Natural language processing technology includes morphological analysis, grammatical analysis, and semantic analysis. For example, the analysis unit uses morphological analysis to segment words in the chat content, grammatical analysis to analyze the structure of sentences, and semantic analysis to understand the meaning of sentences. Step 2: The selection unit selects advertisements based on the content analyzed by the analysis unit. The selection unit selects advertisements based on the extracted keywords. The selection unit can also select advertisements by considering the user's past behavioral history and interests. For example, the selection unit prioritizes the display of advertisements for leisure spots to users who have previously searched for information about leisure spots. Step 3: The display unit displays the advertisements selected by the selection unit. The display unit displays advertisements in advertisement slots within the messenger application. Advertisement slots include banner advertisements, text advertisements, and video advertisements. For example, the display unit can display banner advertisements at the top of the chat screen. The display unit can also display text advertisements at the bottom of the chat screen. Furthermore, the display unit can display video advertisements in the center of the chat screen. Some or all of the above-described processing in the display unit may be performed using AI, or may be performed without using AI. For example, the display unit can use an AI model for displaying advertisements, taking as input the advertisements selected by the selection unit, and display the advertisements. Specifically, in Step 1, the analysis unit receives, as input data, chat content (UTF-8 encoded string array, audio data: 16 kHz WAV format, image data: JPEG/PNG format), performs preprocessing such as text tokenization and morphological analysis, noise removal and acoustic feature extraction from audio, and facial expression feature extraction from images, and uses natural language processing AI models (BERT, Transformer), speech emotion recognition models (RNN, CNN-LSTM), and facial expression recognition models (ResNet) to perform keyword extraction, emotion estimation, and topic classification. Examples of input to the AI model include “Text: I want to go to a leisure spot”, “Audio: speech with an excited tone”, “Image: smiling expression”. Examples of output from the AI model include “Extracted keywords: leisure spot, travel”, “Emotion label: positive, score: 0.85”, “Topic: travel”. In Step 2, the selection unit receives, as input data, the output of the analysis unit (keywords, emotion labels, topics) and the user's behavioral history (e.g., past search history, click history, purchase history), and uses an advertisement selection AI model (gradient boosting decision tree, random forest, Transformer) to calculate relevance scores for each advertisement candidate (e.g., leisure spot advertisement 0.92, travel advertisement 0.88) and generate an optimal advertisement list. Examples of output from the AI model include “Advertisement ID:12345, relevance: 0.92”, “Advertisement ID:67890, relevance: 0.88”. In Step 3, the display unit receives, as input data, the output of the selection unit (advertisement ID, display method score, display position, display format), and uses an advertisement display AI model (multilayer perceptron, decision tree) to automatically determine the layout and display format of advertisements (e.g., banner, text, video) and render them on the user interface. Examples of output from the AI model include “Advertisement ID:12345, display method: banner top”, “Advertisement ID:67890, display method: video center”. In subsequent processing, advertisement display results and click events are sent to the advertisement effectiveness measurement unit and used for advertisement effectiveness analysis and algorithm optimization. Unlike conventional static advertisement selection and display or manual analysis, the present system combines AI-based multimodal data analysis, advertisement selection, and automatic optimization of display parameters, resulting in significant improvements in the accuracy, real-time performance, and user experience of advertisement recommendation and display. Application fields include messenger applications, SNS, EC sites, video streaming services, and other information services requiring interactive advertisement recommendation.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described analysis unit, selection unit, display unit, collection unit, and measurement unit is implemented by at least one of, for example, the smart device 14 and the data processing apparatus 12. For example, the analysis unit is implemented by a processor 46 of the smart device 14 and analyzes chat content of a messenger application. The selection unit is implemented, for example, by a specific processing unit 290 of the data processing apparatus 12 and selects an advertisement based on the analyzed content. The display unit is implemented, for example, by a control unit 46A of the smart device 14 and displays the selected advertisement in an advertisement slot within the messenger application. The collection unit is implemented, for example, by a specific processing unit 290 of the data processing apparatus 12 and collects a user's behavioral history. The measurement unit is implemented, for example, by a specific processing unit 290 of the data processing apparatus 12 and measures the effectiveness of the advertisement. The correspondence between each unit and the apparatus or control unit is not limited to the examples described above, and various modifications are possible.

### Second Embodiment

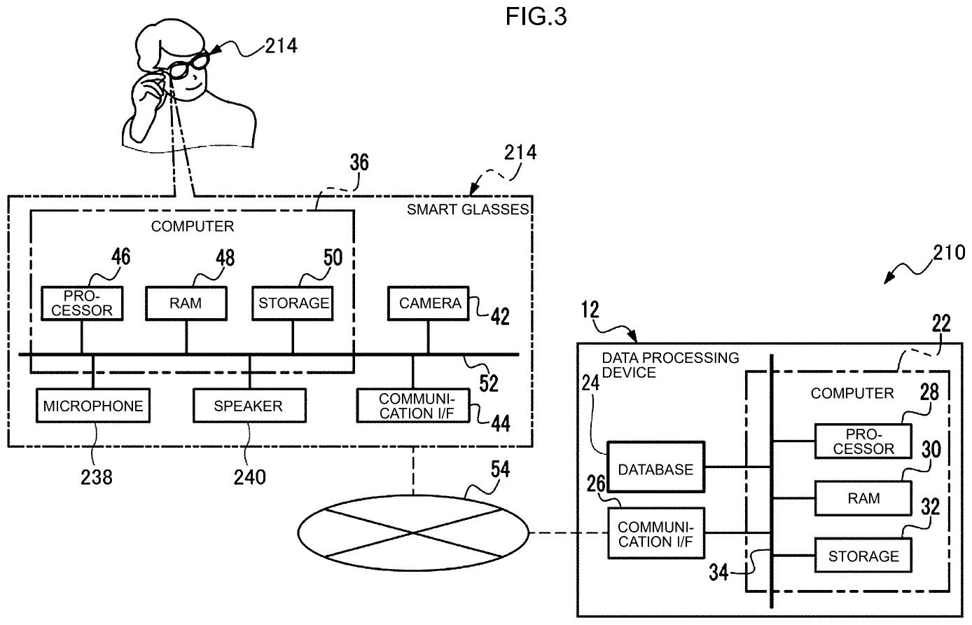

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

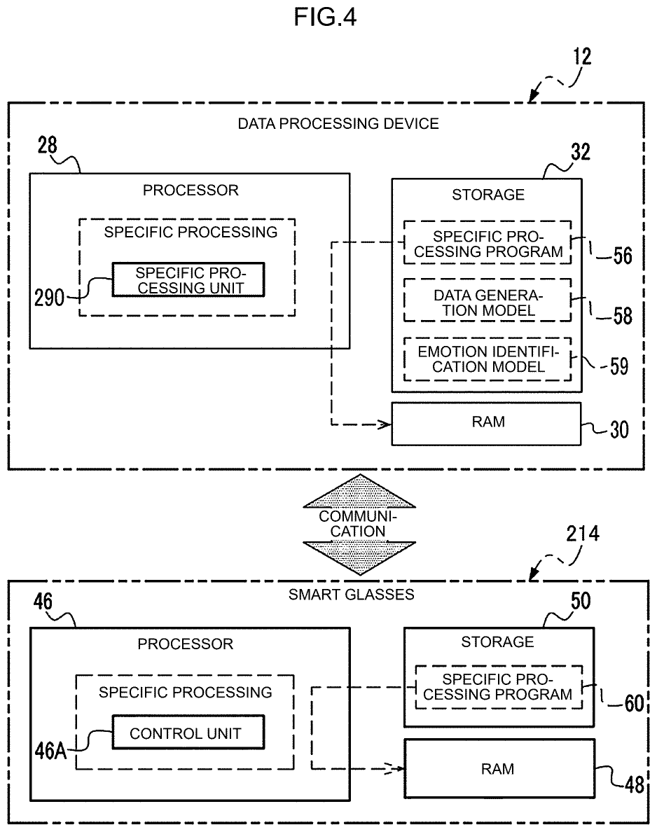

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described analysis unit, selection unit, display unit, collection unit, and measurement unit is implemented by at least one of, for example, the smart glasses 214 and the data processing apparatus 12. For example, the analysis unit is implemented by a processor 46 of the smart glasses 214 and analyzes chat content of a messenger application. The selection unit is implemented, for example, by a specific processing unit 290 of the data processing apparatus 12 and selects an advertisement based on the analyzed content. The display unit is implemented, for example, by a control unit 46A of the smart glasses 214 and displays the selected advertisement in an advertisement slot within the messenger application. The collection unit is implemented, for example, by a specific processing unit 290 of the data processing apparatus 12 and collects a user's behavioral history. The measurement unit is implemented, for example, by a specific processing unit 290 of the data processing apparatus 12 and measures the effectiveness of the advertisement. The correspondence between each unit and the apparatus or control unit is not limited to the examples described above, and various modifications are possible.

### Third Embodiment

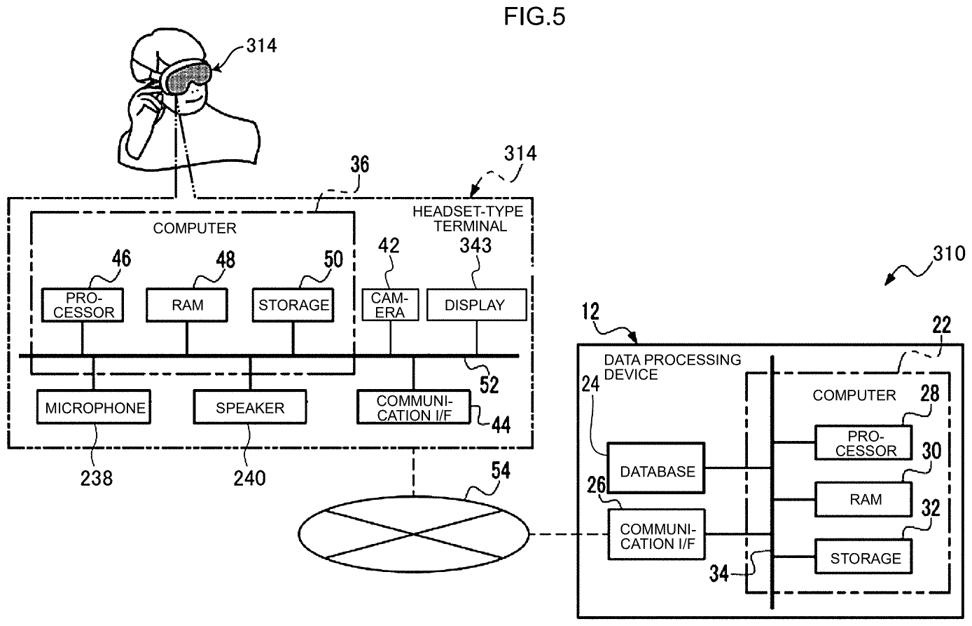

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

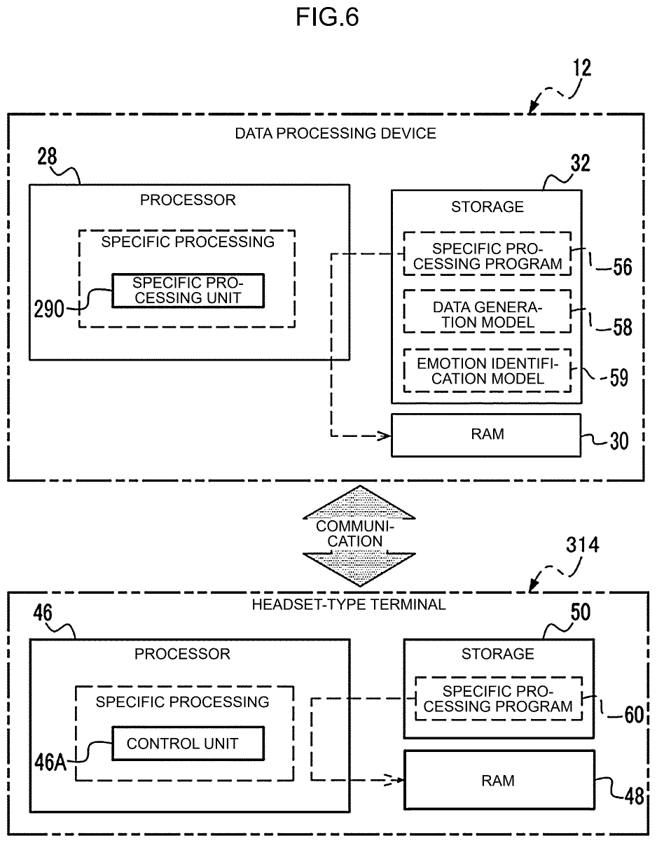

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described analysis unit, selection unit, display unit, collection unit, and measurement unit is implemented by at least one of, for example, the headset-type terminal 314 and the data processing apparatus 12. For example, the analysis unit is implemented by a processor 46 of the headset-type terminal 314 and analyzes chat content of a messenger application. The selection unit is implemented, for example, by a specific processing unit 290 of the data processing apparatus 12 and selects an advertisement based on the analyzed content. The display unit is implemented, for example, by a control unit 46A of the headset-type terminal 314 and displays the selected advertisement in an advertisement slot within the messenger application. The collection unit is implemented, for example, by a specific processing unit 290 of the data processing apparatus 12 and collects a user's behavioral history. The measurement unit is implemented, for example, by a specific processing unit 290 of the data processing apparatus 12 and measures the effectiveness of the advertisement. The correspondence between each unit and the apparatus or control unit is not limited to the examples described above, and various modifications are possible.

### Fourth Embodiment

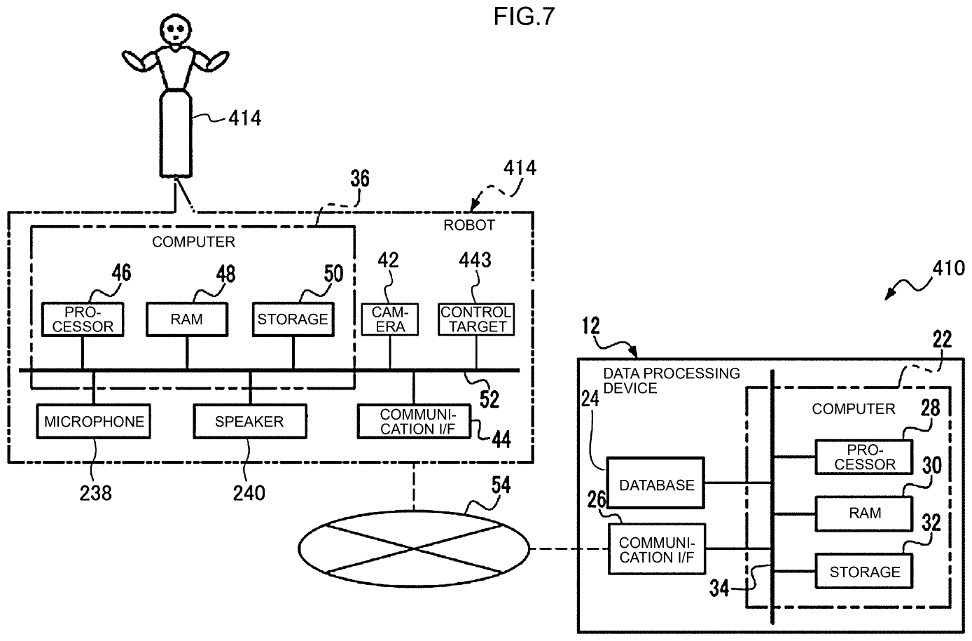

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

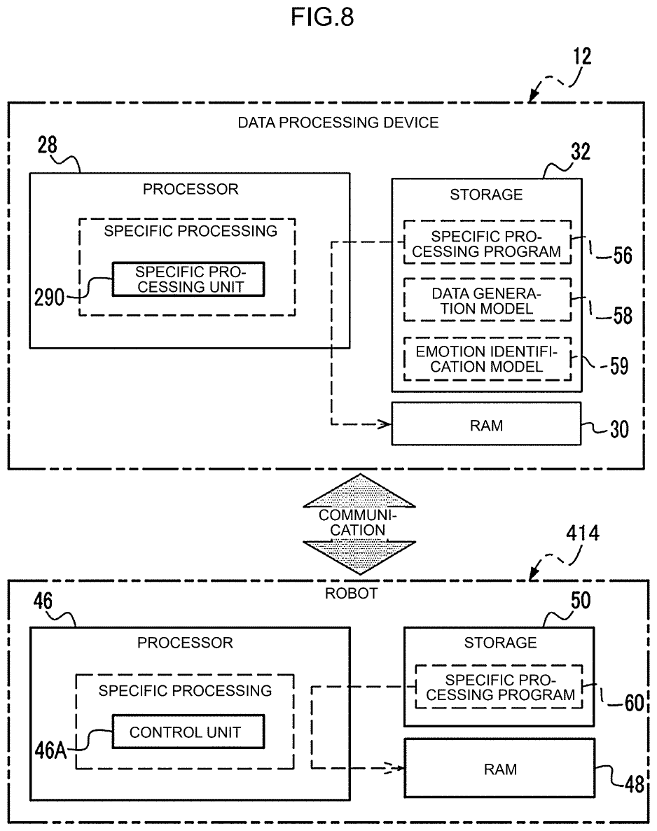

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described analysis unit, selection unit, display unit, collection unit, and measurement unit is implemented by at least one of, for example, the robot 414 and the data processing apparatus 12. For example, the analysis unit is implemented by a processor 46 of the robot 414 and analyzes chat content of a messenger application. The selection unit is implemented, for example, by a specific processing unit 290 of the data processing apparatus 12 and selects an advertisement based on the analyzed content. The display unit is implemented, for example, by a control unit 46A of the robot 414 and displays the selected advertisement in an advertisement slot within the messenger application. The collection unit is implemented, for example, by a specific processing unit 290 of the data processing apparatus 12 and collects a user's behavioral history. The measurement unit is implemented, for example, by a specific processing unit 290 of the data processing apparatus 12 and measures the effectiveness of the advertisement. The correspondence between each unit and the apparatus or control unit is not limited to the examples described above, and various modifications are possible.

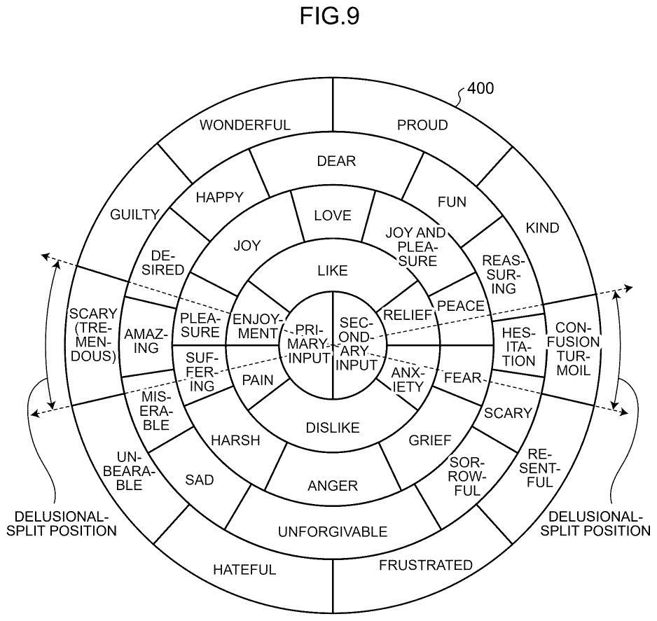

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

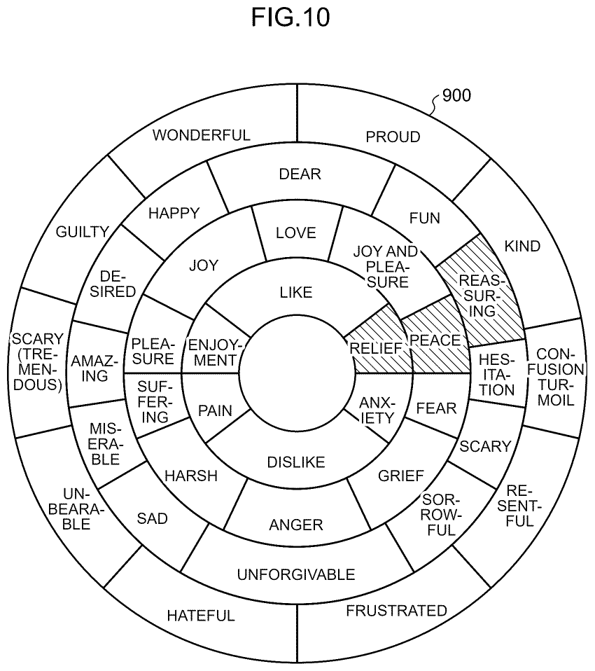

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: an analysis unit configured to analyze chat content; a selection unit configured to select an advertisement based on the content analyzed by the analysis unit; and a display unit configured to display the advertisement selected by the selection unit.
(Supplementary Note 2)The system according to Supplementary Note 1, further comprising a collection unit configured to collect a user's behavioral history.
(Supplementary Note 3)The system according to Supplementary Note 1, further comprising a measurement unit configured to measure the effectiveness of the advertisement.
(Supplementary Note 4)The system according to Supplementary Note 1, wherein the analysis unit analyzes the chat content using natural language processing technology and extracts topics and keywords from the conversation.
(Supplementary Note 5)The system according to Supplementary Note 1, wherein the selection unit selects an advertisement based on the extracted keywords, taking into account the user's past behavioral history and interests.
(Supplementary Note 6)The system according to Supplementary Note 1, wherein the display unit displays the selected advertisement in an advertisement slot within a messenger application.
(Supplementary Note 7)The system according to Supplementary Note 1, wherein the analysis unit estimates the user's emotion and adjusts the method of analyzing the chat content based on the estimated emotion of the user.
(Supplementary Note 8)The system according to Supplementary Note 1, wherein the analysis unit improves the accuracy of extracting topics and keywords by considering the context of the conversation when analyzing the chat content.
(Supplementary Note 9)The system according to Supplementary Note 1, wherein the analysis unit analyzes the chat content by taking into account attribute information of the participants in the conversation when analyzing the chat content.
(Supplementary Note 10)The system according to Supplementary Note 1, wherein the analysis unit estimates the user's emotion and adjusts the method of displaying the analysis result based on the estimated emotion of the user.
(Supplementary Note 11)The system according to Supplementary Note 1, wherein the analysis unit analyzes the chat content by taking into account the geographical background of the conversation when analyzing the chat content.
(Supplementary Note 12)The system according to Supplementary Note 1, wherein the analysis unit improves the accuracy of analysis by referring to related literature of the conversation when analyzing the chat content.
(Supplementary Note 13)The system according to Supplementary Note 1, wherein the selection unit estimates the user's emotion and adjusts the criteria for selecting advertisements based on the estimated emotion of the user.
(Supplementary Note 14)The system according to Supplementary Note 1, wherein the selection unit optimizes the selection algorithm by referring to past advertisement effectiveness data when selecting advertisements.
(Supplementary Note 15)The system according to Supplementary Note 1, wherein the selection unit selects advertisements by taking into account the user's current interests and living conditions when selecting advertisements.
(Supplementary Note 16)The system according to Supplementary Note 1, wherein the selection unit estimates the user's emotion and adjusts the display order of advertisements based on the estimated emotion of the user.
(Supplementary Note 17)The system according to Supplementary Note 1, wherein the selection unit prioritizes the selection of highly relevant advertisements by taking into account the user's geographical location information when selecting advertisements.
(Supplementary Note 18)The system according to Supplementary Note 1, wherein the selection unit selects relevant advertisements by analyzing the user's social media activity when selecting advertisements.
(Supplementary Note 19)The system according to Supplementary Note 1, wherein the display unit estimates the user's emotion and adjusts the method of displaying advertisements based on the estimated emotion of the user.
(Supplementary Note 20)The system according to Supplementary Note 1, wherein the display unit selects an optimal display method by referring to the user's past advertisement click history when displaying advertisements.
(Supplementary Note 21)The system according to Supplementary Note 1, wherein the display unit customizes the display method by taking into account the user's device information when displaying advertisements.
(Supplementary Note 22)The system according to Supplementary Note 1, wherein the display unit estimates the user's emotion and adjusts the frequency of displaying advertisements based on the estimated emotion of the user.
(Supplementary Note 23)The system according to Supplementary Note 1, wherein the display unit selects an optimal display method by taking into account the user's geographical location information when displaying advertisements.
(Supplementary Note 24)The system according to Supplementary Note 1, wherein the display unit proposes a display method by analyzing the user's social media activity when displaying advertisements.
(Supplementary Note 25)The system according to Supplementary Note 2, wherein the collection unit estimates the user's emotion and adjusts the timing of collecting behavioral history based on the estimated emotion of the user.
(Supplementary Note 26)The system according to Supplementary Note 2, wherein the collection unit selects an optimal collection method by analyzing the user's past behavioral patterns when collecting behavioral history.
(Supplementary Note 27)The system according to Supplementary Note 2, wherein the collection unit estimates the user's emotion and determines the priority of behavioral history to be collected based on the estimated emotion of the user.
(Supplementary Note 28)The system according to Supplementary Note 2, wherein the collection unit prioritizes the collection of highly relevant behavioral history by taking into account the user's geographical location information when collecting behavioral history.
(Supplementary Note 29)The system according to Supplementary Note 3, wherein the measurement unit estimates the user's emotion and adjusts the method of measuring advertisement effectiveness based on the estimated emotion of the user.
(Supplementary Note 30)The system according to Supplementary Note 3, wherein the measurement unit optimizes the measurement algorithm by referring to past measurement data when measuring advertisement effectiveness.
(Supplementary Note 31)The system according to Supplementary Note 3, wherein the measurement unit estimates the user's emotion and adjusts the method of displaying measurement results based on the estimated emotion of the user.
(Supplementary Note 32)The system according to Supplementary Note 3, wherein the measurement unit performs measurement by taking into account the user's geographical location information when measuring advertisement effectiveness.

What is claimed is:

1. A system comprising:
a communication interface configured to communicate with a client terminal via a packet-switched network;
a processor;
a random-access memory;
a memory storing a data generation model obtained by deep learning on a neural network, and an emotion identification model;
a database; and
circuitry configured to:
receive, from the client terminal via the communication interface and the packet-switched network, chat data comprising at least one of text data, voice data, or image data;
analyze the chat data using a natural language processing model based on a Transformer architecture to extract at least one of a keyword or a topic label from the chat data;
estimate an emotion of a user by applying the emotion identification model to the chat data;
calculate, using the data generation model, a relevance score for each of a plurality of content items stored in the database, the relevance score being based on the extracted keyword or topic label, the estimated emotion, and a behavioral history of the user stored in the database;
select a content item from the plurality of content items based on the calculated relevance scores; and
transmit the selected content item to the client terminal via the communication interface and the packet-switched network, the selected content item causing the client terminal to render the selected content item in a display region of an application executed on the client terminal.

2. The system according to claim 1, wherein the natural language processing model performs morphological analysis, dependency parsing, and semantic analysis using contextual embedding to extract the keyword or topic label as a probability distribution over a plurality of topic categories.

3. The system according to claim 1, wherein the circuitry is further configured to collect the behavioral history of the user by acquiring, from the client terminal via the communication interface, at least one of browsing history, purchase history, or click history, and storing the acquired behavioral history in the database.

4. The system according to claim 1, wherein the circuitry is further configured to estimate the emotion by inputting at least one of the text data, the voice data, or the image data into a multimodal emotion estimation model comprising at least one of a text emotion classification model, a facial expression recognition model, or a voice emotion recognition model, and integrating outputs of the multimodal emotion estimation model to generate an emotion label and an emotion score.

5. The system according to claim 1, wherein the circuitry is further configured to adjust a method of analyzing the chat data based on the estimated emotion, such that when the estimated emotion indicates excitement, the circuitry preferentially extracts positive keywords, and when the estimated emotion indicates a negative state, the circuitry preferentially extracts negative keywords.

6. The system according to claim 1, wherein the circuitry is further configured to analyze the chat data by considering context of a conversation, the context comprising at least one of preceding and following conversation content or related topics, and to adjust weighting for keyword extraction based on a flow of the conversation and a frequency of repeated words.

7. The system according to claim 1, wherein the circuitry is further configured to analyze the chat data by considering attribute information of participants in a conversation, the attribute information comprising at least one of age, gender, occupation, or hobby, and to adjust analysis parameters according to the attribute information.

8. The system according to claim 1, wherein the circuitry is further configured to analyze the chat data by considering a geographical background of a conversation, the geographical background comprising at least one of a place name, a location of participants, or a regional event, and to adjust analysis parameters according to the geographical background.

9. The system according to claim 1, wherein the circuitry is further configured to adjust a selection criterion for the content item based on the estimated emotion, such that when the estimated emotion indicates excitement, the circuitry preferentially selects content items having a positive attribute, and when the estimated emotion indicates a negative state, the circuitry preferentially selects content items having an encouraging attribute.

10. The system according to claim 1, wherein the circuitry is further configured to optimize the calculation of the relevance score by referring to past effectiveness data comprising at least one of a click-through rate, a conversion rate, or an engagement rate associated with previously selected content items.

11. The system according to claim 1, wherein the circuitry is further configured to select the content item by considering at least one of a current interest or a current living condition of the user, the current interest being determined from at least one of a recent search history or social media post content received from the client terminal.

12. The system according to claim 1, wherein the circuitry is further configured to adjust a display order of the plurality of content items based on the estimated emotion, such that when the estimated emotion indicates excitement, content items having a positive attribute are transmitted with a higher priority, and when the estimated emotion indicates a negative state, content items having an encouraging attribute are transmitted with a higher priority.

13. The system according to claim 1, wherein the circuitry is further configured to select the content item by considering geographic location information of the user received from the client terminal, and to calculate a regional suitability score for each content item based on the geographic location information.

14. The system according to claim 1, wherein the circuitry is further configured to adjust a display method of the selected content item based on the estimated emotion, the display method comprising at least one of a highlight color, a font size, an animation effect, or a display position.

15. The system according to claim 1, wherein the circuitry is further configured to select an optimal display method for the selected content item by referring to a past click history of the user stored in the database.

16. The system according to claim 1, wherein the circuitry is further configured to customize a display method of the selected content item based on device information of the client terminal, the device information comprising at least one of a device type, an operating system version, or a screen resolution.

17. The system according to claim 1, wherein the circuitry is further configured to measure effectiveness of the selected content item by collecting at least one of a click event, a display count, or a conversion event from the client terminal via the communication interface, and to optimize the calculation of the relevance score based on the measured effectiveness.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor comprising at least one of a CPU, a GPU, or a TPU;
a random-access memory;
a memory storing a data generation model obtained by deep learning on a neural network, and an emotion identification model;
a database; and
circuitry configured to:
receive, from the client terminal via the communication interface and the packet-switched network, chat data comprising at least one of text data input via the touch panel, voice data captured by the microphone, or image data captured by the camera;
preprocess the chat data by performing at least one of noise removal, tokenization, speech-to-text conversion, or feature extraction using a CNN-based image encoder;
analyze the preprocessed chat data using a natural language processing model based on a Transformer architecture to extract at least one of a keyword or a topic label as a probability distribution;
estimate an emotion of a user by applying the emotion identification model to the chat data, the emotion identification model comprising at least one of a text emotion classification model, a facial expression recognition model, or a voice emotion recognition model;
calculate, using the data generation model, a relevance score for each of a plurality of content items stored in the database, the relevance score being based on the extracted keyword or topic label, the estimated emotion, and a behavioral history of the user;
select a content item from the plurality of content items based on the calculated relevance scores; and
transmit the selected content item to the client terminal via the communication interface and the packet-switched network, the selected content item causing the client terminal to render the selected content item via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a memory storing a data generation model obtained by deep learning on a neural network and an emotion identification model, a database, and a communication interface, the method comprising:
receiving, from a client terminal via the communication interface and a packet-switched network, chat data comprising at least one of text data, voice data, or image data;
analyzing the chat data using a natural language processing model based on a Transformer architecture to extract at least one of a keyword or a topic label from the chat data;
estimating an emotion of a user by applying the emotion identification model to the chat data;
calculating, using the data generation model, a relevance score for each of a plurality of content items stored in the database, the relevance score being based on the extracted keyword or topic label, the estimated emotion, and a behavioral history of the user stored in the database;
selecting a content item from the plurality of content items based on the calculated relevance scores; and
transmitting the selected content item to the client terminal via the communication interface and the packet-switched network.
